(19) United States
(12) Patent Application Publication
(10) Pub. No.: US 2025/0286241 A1
(43) Pub. Date: Sep. 11, 2025

(54) BATTERY

(71) Applicant: Panasonic Intellectual Property Management Co., Ltd., Osaka (JP)

(72) Inventor: EIICHI KOGA, Hokkaido (JP)

(21) Appl. No.: 19/215,967

(22) Filed: May 22, 2025

Related U.S. Application Data
(63) Continuation of application No. PCT/JP2023/028495, filed on Aug. 4, 2023.

(30) Foreign Application Priority Data
Dec. 8, 2022 (JP) 2022-196645

(51) Int. Cl. H01M 50/533; H01M 10/0562; H01M 10/0585; H01M 50/534; H01M 50/586

(52) U.S. Cl. CPC H01M 50/533; H01M 10/0562; H01M 10/0585; H01M 50/534; H01M 50/586; H01M 2300/0068

(57) ABSTRACT

A battery according to the present disclosure includes a first electrode layer, a second electrode layer, and a solid electrolyte layer that is disposed between the first electrode layer and the second electrode layer. The first electrode layer includes a first active material layer, and a first current collector layer and a first conductor layer that are disposed on a first main surface of the first active material layer. The first conductor layer is made of a material different from a material of the first current collector layer, is positioned adjacent to a first side surface of the battery, and is electrically connected to the first current collector layer. The battery further includes a first lead-out conductor member that is electrically connected to the first conductor layer.

### BACKGROUND

### 1. Technical Field

The present disclosure relates to a battery.

### 2. Description of the Related Art

Japanese Unexamined Patent Application Publication No. 2021-57322 discloses a laminated battery having a structure such that a current collector layer, which is interposed between a plurality of power generation elements to allow the power generation elements to be laminated, and an insulating layer made of an insulating adhesive are disposed on the same plane. International Publication No. 2018/087970 discloses a laminated battery having a structure such that an insulating layer is formed on a side surface of a laminated body including a current collector layer and an electrode layer.

### SUMMARY

In the related art, there is a demand for a battery having high reliability.

In one general aspect, the techniques disclosed here feature a battery including a first electrode layer, a second electrode layer, and a solid electrolyte layer that is disposed between the first electrode layer and the second electrode layer. The first electrode layer includes a first active material layer, and a first current collector layer and a first conductor layer that are disposed on a first main surface of the first active material layer. The first conductor layer is made of a material different from a material of the first current collector layer, is positioned adjacent to a first side surface of the battery, and is electrically connected to the first current collector layer. The battery further includes a first lead-out conductor member that is electrically connected to the first conductor layer.

The present disclosure can provide a battery having high reliability.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates a sectional view and a plan view illustrating the schematic configuration of a battery 1000 according to a first embodiment;

FIG. 2 illustrates a sectional view and a plan view illustrating the schematic configuration of a battery according to a modification of the first embodiment;

FIG. 3 illustrates a sectional view and a plan view illustrating the schematic configuration of a battery 1100 according to a second embodiment;

FIG. 4 illustrates a sectional view and a plan view illustrating the schematic configuration of a battery 1200 according to a third embodiment;

FIG. 5 illustrates a sectional view and a plan view illustrating the schematic configuration of a battery 1300 according to a fourth embodiment;

FIG. 6 illustrates a sectional view and a plan view illustrating the schematic configuration of a battery 1400 according to a fifth embodiment;

FIG. 7 illustrates a sectional view and a plan view illustrating the schematic configuration of a battery 1500 according to a sixth embodiment;

FIG. 8 illustrates a sectional view and a plan view illustrating the schematic configuration of a battery 1600 according to a seventh embodiment; and

FIG. 9 illustrates a sectional view and a plan view illustrating the schematic configuration of a battery 1700 according to an eighth embodiment.

### DETAILED DESCRIPTIONS

Hereafter, embodiments of the present disclosure will be described in detail with reference to the drawings.

The embodiments described below are each a general or specific example. The values, shapes, materials, elements, arrangements of elements, connection configurations of elements, manufacturing steps, order of manufacturing steps, and the like described in the following embodiments are examples, and do not limit the present disclosure. Among the elements in the embodiments, elements that are not described in the independent claim that represents the broadest concept are optional elements.

In the present specification, terms that represent the shapes of elements, such as rectangular, and numerical ranges not only have strict meanings but also have meanings of substantially an equivalent range, for example, with a difference of about several percents.

Each figure is a schematic view, and is not necessarily drawn strictly. Accordingly, for example, the scales and the like do not necessarily coincide with each other between the figures. In the figures, substantially the configurations are denoted by the same numerals, and redundant descriptions thereof will be omitted or simplified.

In the present specification and the drawings, the x axis, the y axis, and the z axis are the three axes of a three-dimensional orthogonal coordinate system. In each embodiment, the z-axis direction is the thickness of direction of a battery. In the present specification, unless otherwise noted, “thickness direction” refers to a direction perpendicular to the planes on which layers of a battery are laminated.

In the present specification, “plan view” refers to a view as seen in a laminating direction in which layers of a battery are laminated. In the present specification, “thickness” refers to a length of a battery or each layer in the laminating direction.

In the present specification, unless otherwise noted, regarding a battery and each layer, “side surface” refers to a surface extending in the laminating direction of the layers of the battery, and “main surface” refers to a surface other than the side surface.

In the present specification, “inner” and “outer” in “inner side”, “outer side”, and the like respectively refer to the central side of the battery and the peripheral side of the battery when the battery is seen in the laminating direction of the layers of the battery.

In the present specification, the terms “above” and “below” in the configuration of a battery do not represent the upward direction (vertically above) and the downward direction (vertically below) in absolute spatial recognition, but are used as terms that are defined by a relative positional relationship based on the laminated order in a laminated configuration. The terms “above” and “below” are used, not only when two elements are disposed with a space therebetween and another element is present between the two elements, but also when two elements are disposed very close to each other and the two elements are in contact with each other.

### First Embodiment

Hereafter, a battery according to a first embodiment will be described.

The battery according to the first embodiment includes a first electrode layer, a second electrode layer, and a solid electrolyte layer. The solid electrolyte layer is disposed between the first electrode layer and the second electrode layer.

The first electrode layer includes a first active material layer, and a first current collector layer and a first conductor layer that are disposed on a first main surface of the first active material layer.

The first conductor layer is made of a material different from the material of the first current collector layer, is positioned, on the first main surface of the first active material layer, adjacent to a first side surface of the battery, and is electrically connected to the first current collector layer. Here, “the first conductor layer is made of a material different from the material of the first current collector layer” means that the composition of the material of the first conductor layer is different from the composition of the material of the first current collector layer. For example, the material of the first conductor layer includes at least one component that is not included in the material of the first current collector layer.

The battery further includes a first lead-out conductor member that is electrically connected to the first conductor layer.

With the configuration described above, in the battery according to the first embodiment, the first lead-out conductor member and the first current collector layer are electrically connected via the first conductor layer. As with the first current collector layer, the first conductor layer is disposed on the first main surface of the first active material layer. That is, the first conductor layer is positioned on the same plane as the first current collector layer. In this way, since the first lead-out conductor member and the first current collector layer are electrically connected via the first conductor layer that is positioned on the same plane as the first current collector layer, it is possible to suppress occurrence of a problem in that the bonding between a side surface of the first current collector layer and the first lead-out conductor member is easily disrupted by expansion and contraction of the battery. Accordingly, the battery according to the first embodiment can realize high reliability. Moreover, with this configuration, for example, it is possible to select the material of the first conductor layer from materials that are suitable for bonding with the first lead-out conductor member. For example, with the battery according to the first embodiment, it is also possible to select, as the material of the first conductor layer, a material that is softer than the material of the first current collector layer, and it is also possible to realize a configuration that can further improve reliability.

In the battery according to the first embodiment, at least a part of the first lead-out conductor member may be disposed along the first side surface of the battery. In this case, for example, the battery according to the first embodiment may further include a first-side-surface insulating layer. The first-side-surface insulating layer covers a first side surface of a laminated body composed of the first active material layer, the solid electrolyte layer, and the second active material layer. At least a part of the first lead-out conductor member is disposed on a surface of the first-side-surface insulating layer. With the battery according to the first embodiment having this configuration, when a laminated battery is to be formed by laminating a plurality of batteries, it is possible to form an assembled battery having an integrated structure without using lead wires that may break easily. It is possible to select whether to laminate the plurality of batteries to be connected in parallel or in series. Accordingly, with the battery according to the first embodiment, it is possible to realize a small high-capacity battery while realizing high reliability. In this way, with the battery according to the first embodiment, by causing the first conductor layer to absorb deformation due to charging and discharging of the battery or the like, it is possible to realize electrical connection between the first current collector layer and the first lead-out conductor member with high reliability and low resistance, and it is possible to realize a small high-capacity battery having high reliability.

The second electrode layer may have a configuration similar to that of the first electrode layer. That is, the second electrode layer may include a second active material layer, and a second current collector layer and a second conductor layer that are disposed on a first main surface of the second active material layer. The second conductor may be made of a material different from the material of the second current collector layer, may be positioned, on the first main surface of the second active material layer, adjacent to a second side surface of the battery opposite to the first side surface of the battery, and may be electrically connected to the second current collector layer. The battery may further include a second lead-out conductor member that is electrically connected to the second conductor layer. Here, “the second conductor layer is made of a material different from the material of the second current collector layer” means that the composition of the material of the second conductor layer is different from the composition of the material of the second current collector layer. For example, the material of the second conductor layer includes at least one component that is not included in the material of the second current collector layer. With this configuration, the second conductor layer can function in a similar way to the first conductor layer and can provide similar advantageous effects.

As with the first lead-out conductor member, at least a part of the second lead-out conductor member may be disposed along the second side surface of the battery. In this case, for example, the battery according to the first embodiment may further include a second-side-surface insulating layer. The second-side-surface insulating layer covers the second side surface of the laminated body composed of the first active material layer, the solid electrolyte layer, and the second active material layer. At least a part of the second lead-out conductor member is disposed on a surface of the second-side-surface insulating layer. With this configuration, the second lead-out conductor member can function in the same way as the first lead-out conductor member and can provide similar advantageous effects.

Hereafter, one configuration example of the battery according to the first embodiment will be described.

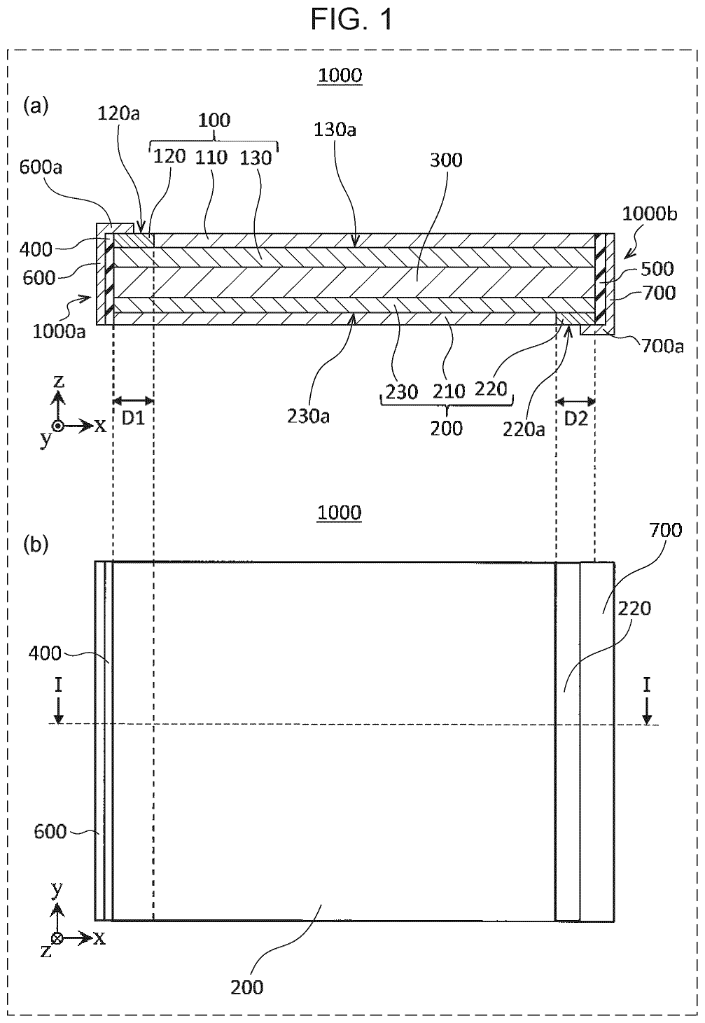

FIG. 1 illustrates a sectional view and a plan view illustrating the schematic configuration of a battery 1000 according to the first embodiment. The battery 1000 illustrated in FIG. 1, which is one configuration example of the battery according to the first embodiment, has the following configuration: the first electrode layer and the second electrode layer have similar configurations; and at least a part of the first lead-out conductor member and at least a part of the second lead-out conductor member are respectively disposed along the first side surface and the second side surface of the battery 1000. However, this configuration is one example, and the second electrode layer may have a configuration different from that of the first electrode layer in the battery 1000. In the battery 1000, the first lead-out conductor member and the second lead-out conductor member need not be disposed along the side surfaces of the battery. In this case, the first-side-surface insulating layer and the second-side-surface insulating layer may be omitted.

FIG. 1(a) is a sectional view of the battery 1000 according to the first embodiment. FIG. 1(b) is a plan view of the battery 1000 according to the first embodiment as seen from below in the z-axis direction. FIG. 1(a) illustrates a cross section taken along line I-I of FIG. 1(b).

As illustrated in FIG. 1, the battery 1000 is a rectangular-plate-shaped battery including a first electrode layer 100, a solid electrolyte layer 300, and a second electrode layer 200 in this order in the laminating direction. The rectangular outer shape is an example, and the outer shape is not limited to this. The first electrode layer 100 and the second electrode layer 200 are disposed opposite to each other with the solid electrolyte layer 300 therebetween. The first electrode layer 100 and the second electrode layer 200 are, for example, in contact with the solid electrolyte layer 300.

The first electrode layer 100 includes a first current collector layer 110, a first conductor layer 120, and a first active material layer 130. The first current collector layer 110 and the first conductor layer 120 are both disposed on a first main surface 130a of the first active material layer 130. That is, the first conductor layer 120 is positioned on the same plane as the first current collector layer 110. For example, the first current collector layer 110 and the first conductor layer 120 are in contact with the first active material layer 130.

The first conductor layer 120 is positioned, on the first main surface 130a of the first active material layer 130, adjacent to a first side surface 1000a of the battery 1000, and is electrically connected to the first current collector layer 110. The first conductor layer 120 is, for example, in contact with the first main surface 130a of the first active material layer 130. The first conductor layer 120 is made of a material different from the material of the first current collector layer 110.

The second electrode layer 200 is disposed opposite to the first electrode layer 100, and is a counter electrode of the first electrode layer 100. For example, if the first electrode layer 100 is a positive electrode, the second electrode is a negative electrode. The second electrode layer 200 includes a second current collector layer 210, a second conductor layer 220, and a second active material layer 230. The second current collector layer 210 and the second conductor layer 220 are both disposed on a first main surface 230a of the second active material layer 230. That is, the second conductor layer 220 is positioned on the same plane as the second current collector layer 210. For example, the second current collector layer 210 and the second conductor layer 220 are in contact with the second active material layer 230.

The second conductor layer 220 is positioned, on the first main surface 230a of the second active material layer 230, adjacent to a second side surface 1000b of the battery 1000 opposite to the first side surface 1000a, and is electrically connected to the second current collector layer 210. The second conductor layer 220 is, for example, in contact with the first main surface 230a of the second active material layer 230. The second conductor layer 220 is made of a material different from the material of the second current collector layer 210.

Both main surfaces of the solid electrolyte layer 300 are disposed in contact with the first active material layer 130 and the second active material layer 230.

The battery 1000 according to the first embodiment further includes a first-side-surface insulating layer 400, a second-side-surface insulating layer 500, a first lead-out conductor member 600, and a second lead-out conductor member 700.

The first-side-surface insulating layer 400 covers a first side surface of a laminated body composed of the first active material layer 130, the solid electrolyte layer 300, and the second active material layer 230. The first side surface of the laminated body is a side surface at a position corresponding to the first side surface 1000a of the battery 1000. As illustrated in FIG. 1(a), the first-side-surface insulating layer 400 may cover, in addition to the first side surface of the laminated body, a side surface of the first conductor layer 120 and a side surface of the second current collector layer 210. The second-side-surface insulating layer 500 covers a second side surface of the laminated body opposite to the first side surface of the laminated body. The second side surface of the laminated body is a side surface at a position corresponding to the second side surface 1000b of the battery 1000. As illustrated in FIG. 1(a), the second-side-surface insulating layer 500 may cover, in addition to the second side surface of the laminated body, a side surface of the second conductor layer 220 and a side surface of the first current collector layer 110. The first lead-out conductor member 600 is disposed on at least a part of a surface of the first-side-surface insulating layer 400, and is in contact with the first conductor layer 120. The second lead-out conductor member 700 is disposed on at least a part of a surface of the second-side-surface insulating layer 500, and is in contact with the second conductor layer 220.

In the battery 1000 illustrated in FIG. 1, the first conductor layer 120 and the first current collector layer 110 are in contact with each other at side surfaces thereof, but this is not a limitation. It is sufficient that the first conductor layer 120 and the first current collector layer 110 be electrically connected. These layers need not be in direct contact with each other or may have non-contacting portions. A gap may be provided between the first conductor layer 120 and the first current collector layer 110. The second conductor layer 220 and the second current collector layer 210 are in contact with each other at side surfaces thereof, but this is not a limitation. It is sufficient that the second conductor layer 220 and the second current collector layer 210 be electrically connected. These layers need not be in direct contact with each other or may have non-contacting portions. A gap may be provided between the second conductor layer 220 and the second current collector layer 210. For example, when a gap is provided between the side surface of the first conductor layer 120 and the side surface of the first current collector layer 110, which are adjacent to each other, the gap serves as an absorber of a stress that is generated due to the difference in thermal expansion coefficient between the first conductor layer 120 and the first current collector layer 110 when temperature changes in a thermal cycle or the like, and warping of the battery 1000 can be suppressed. If the stress that causes warping of the battery 1000 is large, the battery 1000 may break. Accordingly, such a gap can suppress breakage of the battery 1000. The shape of the first conductor layer 120 and the shape of the gap provided between the first conductor layer 120 and the first current collector layer 110 are not particularly limited, and may be adjusted in any appropriate way in order to adjust warping of the battery 1000. It is desirable that the first conductor layer 120 be made of a conductive material that is softer than the first current collector layer 110. The first conductor layer 120 may include, for example, a conductive resin.

The above description of the first conductor layer 120 and the first current collector layer 110 also applies to the second conductor layer 220 and the second current collector layer 210.

Here, in a battery according to the present disclosure, the softness of a constituent member can be evaluated and compared by performing a micro-Vickers hardness test or the like by using a cross section of the constituent member that is cut out flatly by ion milling or the like.

In the battery 1000 illustrated in FIG. 1, the shape of the bonding portion between the first conductor layer 120 and the first current collector layer 110 is a straight line in plan view, but this is not a limitation. For example, the shape of the bonding portion may be, instead of a straight line, an arc, a curve, a zigzag such as a saw-tooth shape, or the like. When the bonding portion has such a shape that is not a straight line, for example, mechanical strength against bending is improved, and therefore the reliability of the battery is further increased.

The first-side-surface insulating layer 400 and the second-side-surface insulating layer 500 are respectively disposed on the first side surface 1000a of the battery 1000 and on the second side surface 1000b opposite to the first side surface 1000a. In the battery 1000 illustrated in FIG. 1, the first-side-surface insulating layer 400 and the second-side-surface insulating layer 500 are formed on the side surfaces of the first electrode layer 100, the solid electrolyte layer 300, and the second electrode layer 200. However, regions in which the first-side-surface insulating layer 400 and the second-side-surface insulating layer 500 are to be disposed are not limited to these. For example, the side surfaces of the first conductor layer 120 and the second conductor layer 220 need not be covered by the first-side-surface insulating layer 400 and the second-side-surface insulating layer 500.

The first lead-out conductor member 600 is disposed, for example, on at least a part of the surface of the first-side-surface insulating layer 400. The first lead-out conductor member 600 may include a wraparound portion 600a that is continuous from the first side surface 1000a of the battery 1000 onto a first main surface 120a of the first conductor layer 120 that does not face the first active material layer 130, and the first lead-out conductor member 600 may be in contact with the first conductor layer 120 at the first main surface 120a of the first conductor layer 120. In other words, the first lead-out conductor member 600 may be connected to the first conductor layer 120 by covering a part of the first-side-surface insulating layer 400 and wrapping around a corner portion of the battery 1000 to cover the first main surface 120a of the first conductor layer 120. The second lead-out conductor member 700 is disposed, for example, on at least a part of a surface of the second-side-surface insulating layer 500. The second lead-out conductor member 700 may include a wraparound portion 700a that is continuous from the second side surface 1000b of the battery 1000 onto a first main surface 220a of the second conductor layer 220 that does not face the second active material layer 230, and the second lead-out conductor member 700 may be in contact with the second conductor layer 220 at the first main surface 220a of the second conductor layer 220. In other words, the second lead-out conductor member 700 may be connected to the second conductor layer 220 by covering a part of the second-side-surface insulating layer 500 and wrapping around a corner portion of the battery 1000 to cover the first main surface 220a of the second conductor layer 220. Here, the wraparound portions 600a and 700a correspond to ridge portions of the first lead-out conductor member 600 and the second lead-out conductor member 700 from the side surfaces to the main surfaces of the battery 1000 in a cross section of the battery 1000.

As described above, the battery 1000 may satisfy, for example, at least one selected from the group consisting of the following (A-1) and (B-1): (A-1) The first lead-out conductor member 600 includes the wraparound portion 600a that is continuous from the first side surface 1000a of the battery 1000 onto the first main surface 120a of the first conductor layer 120 that does not face the first active material layer 130, and the first lead-out conductor member 600 is in contact with the first conductor layer 120 at the first main surface 120a of the first conductor layer 120. (B-1) The second lead-out conductor member 700 includes the wraparound portion 700a that is continuous from the second side surface 1000b of the battery 1000 onto the first main surface 220a of the second conductor layer 220 that does not face the second active material layer 230, and the second lead-out conductor member 700 is in contact with the second conductor layer 220 at the first main surface 220a of the second conductor layer 220.

With the configuration described above, the area of contact between the first lead-out conductor member 600 and the first conductor layer 120 and the area of contact between the second lead-out conductor member 700 and the second conductor layer 220 are increased. Thus, the electrical resistance between the first lead-out conductor member 600 and the first conductor layer 120 and the electrical resistance between the second lead-out conductor member 700 and the second conductor layer 220 can each be reduced. Moreover, with the wraparound portions 600a and 700a, it is possible to realize reduction of the connection resistance between the first lead-out conductor member and the first conductor layer and reduction of the connection resistance between the second lead-out conductor member and the second conductor layer without increasing the size of the battery 1000. Accordingly, it is possible to obtain a small high-capacity battery having small resistance loss.

The thickness of the wraparound portion 600a of the first lead-out conductor member 600 may be smaller than the thickness of the first lead-out conductor member 600 on the first side surface 1000a of the battery 1000 and the thickness of the first lead-out conductor member 600 on the first main surface 120a of the first conductor layer 120. The thickness of the wraparound portion 700a of the second lead-out conductor member 700 may be smaller than the thickness of the second lead-out conductor member 700 on the second side surface 1000b of the battery 1000 and the thickness of the second lead-out conductor member 700 on the first main surface 220a of the second conductor layer 220.

With the configuration described above, it is possible to suppress a crack in the first lead-out conductor member 600 and the second lead-out conductor member 700 that is easily generated, for example, along a ridge at the wraparound portions 600a and 700a, which are bent, due to expansion/contraction stress of the battery 1000 in charging and discharging operations. Accordingly, it is possible to improve the reliability of the battery 1000.

In the battery 1000 according to the first embodiment, the first active material layer 130 and the second active material layer 230, the first conductor layer 120 and the second conductor layer 220, and the first current collector layer 110 and the second current collector layer 210 respectively have the same sizes and have the same contour shapes in plan view. However, this is not a limitation on the shapes of these members. For example, the first conductor layer 120 and the second conductor layer 220 may have different outer shapes. Thus, for example, by examining the relationship between the sizes of the first conductor layer 120 and the second conductor layer 220 by using a technology such as image recognition, it is possible to determine, from the outer shapes, on which of a positive electrode and a negative electrode the conductor layer is provided and to make correction as necessary. Accordingly, it is possible to reduce occurrence of polarity error when the battery is being manufactured or used.

The first electrode layer 100 may be a positive electrode, and the second electrode layer 200 may be a negative electrode. To be specific, the first current collector layer 110 may be a positive-electrode current collector layer, and the first active material layer 130 may be a positive-electrode active material layer. The second current collector layer 210 may be a negative-electrode current collector layer, and the second active material layer 230 may be a negative-electrode active material layer.

In the present specification, the first current collector layer 110 and the second current collector layer 210 may be collectively and simply referred to as “current collector”.

In the present specification, the first conductor layer 120 and the second conductor layer 220 may be collectively and simply referred to as “conductor layer”.

In the present specification, the first active material layer 130 and the second active material layer 230 may be collectively and simply referred to as “active material layer”.

In the present specification, the first-side-surface insulating layer 400 and the second-side-surface insulating layer 500 may be collectively and simply referred to as “side-surface insulating layer”.

In the present specification, the first lead-out conductor member 600 and the second lead-out conductor member 700 may be collectively and simply referred to as “lead-out conductor member”.

Hereafter, each element of the battery 1000 will be described. In the following description, a basic configuration of a battery formed by the active material layer and the solid electrolyte layer 300 may be referred to as a battery element.

### Current Collector Layer

The current collector layer is made of a material having conductivity. Examples of the material of the current collector layer include stainless steel, nickel (Ni), aluminum (Al), iron (Fe), titanium (Ti), copper (Cu), palladium (Pd), gold (Au), platinum (Pt), and an alloy of two or more of these. As the current collector layer, a foil-shaped member, a plate-shaped member, or a mesh-shaped member made of any of these materials can be used.

The material of the current collector layer can be selected in consideration of the manufacturing process, the use temperature, the operating potential of the battery applied to current collector layer, or the conductivity. The material of the current collector layer can be selected also in accordance with the tensile strength or the heat resistance required for the battery.

The current collector layer may be a high-strength electrolytic copper foil or a cladding member in which foils of different metals are laminated.

The thickness of the current collector layer is, for example, greater than or equal to 10 μm and less than or equal to 100 μm.

In order to increase the adhesion with the active material layer, the current collector layer may have a rough surface having be protrusions and recesses.

To the surface of the current collector layer, an adhesive component such as an organic binder may be applied. To the surface of the current collector layer, insulating particles, conductive particles, or semiconductive particles may be affixed. Thus, the bondability at the interface between the current collector layer and another layer (such as the active material layer) is increased, and it is possible to increase the mechanical reliability, the thermal reliability, the cycle characteristics, and the like of the battery 1000.

### Conductor Layer

The conductor layer may have, for example, a width that is greater than or equal to the thickness of the current collector layer. Here, the “width” of the conductor layer is defined as the distance in plan view from an end portion of the conductor layer on the outer side of the battery 1000 to an end portion of the conductor layer on the inner side of the battery 1000. The width corresponds to the distances denoted by “D1” and “D2” in FIG. 1.

The thickness of the conductor layer may be the same as the thickness of the current collector layer that is electrically connected, but this is not a limitation. For example, the thickness of the conductor layer may be greater than the thickness of the current collector layer that is electrically connected. Thus, the electrical resistance of a connection portion with the lead-out conductor member is reduced, the performance of a high-power operation is improved, and the heat generated at the connection portion is reduced. Accordingly, the performance and the reliability of the battery 1000 are improved. However, when the thickness of the conductor layer is increased excessively, volume energy density and weight energy density decrease. Accordingly, it is desirable that the thickness of the conductor layer be appropriately adjusted in consideration of volume energy density and weight energy density. The conductor layer may be thinner than the current collector layer that is electrically connected. Thus, it is possible to improve volume energy density and weight energy density within the range of desirable performance and reliability.

It is sufficient that the conductor layer be made of a material having conductivity, and the material is not particularly limited. A material having high conductivity is suitable, because such as material can reduce the resistance loss of the battery 1000. Thus, it is possible to obtain the battery 1000 that has high performance and in which heat generation is suppressed.

The conductor layer may be, for example, a plate-shaped member including a metal material. For example, a foil-shaped member, a plate-shaped member, or a mesh-shaped member each made of a metal can be used. With this configuration, a side-surface portion of the battery 1000, which may easily break due to an external impact, can be reinforced by a plate-shaped member including a metal material that is more rigid than the active material layer and the solid electrolyte layer 300, which are constituent members of a battery element. Accordingly, it is possible to realize the battery 1000 having high mechanical reliability.

The conductor layer may include, for example, a resin. With this configuration, the elasticity, that is, the softness of the resin can absorb expansion and contraction of an active material caused by charging and discharging. Accordingly, the adhesion of the bonding surface between the conductor layer and the active material layer and the adhesion of the bonding surface between the conductor layer and the lead-out conductor member can be maintained. Thus, it is possible to realize the battery 1000 having excellent charge-discharge cycle characteristics, because the conductor layer, the lead-out conductor member, and the active material layer are strongly connected.

The conductor layer may be made of a material including metal particles and a resin, such as a conductive resin. As the metal particles, metal particles of Ag, Cu, Pt, Pd, or the like can be used. The metal particles may include mixture powder of two or more metals, or may include alloy powder. The size and shape of metal particles are not particularly limited. It is desirable that the conductor layer be softer than the current collector layer. Accordingly, a conductive resin is suitable as the material of the conductor layer. It is possible to compare the hardness of the conductor layer and the hardness of the current collector layer by using an evaluation method such as a micro-Vickers hardness test.

The conductor layer may include, for example, a thermosetting resin. That is, a thermosetting conductive resin can be used for the conductor layer. With this configuration, since it is possible to change the degree of curing by changing the temperature and time for thermally curing thermosetting resin, the hardness of the same resin material can be adjusted. It is possible to examine the progress of curing of a thermosetting resin performing by Fourier transform infrared spectroscopy (FTIR) (for observing a microscopic region) or differential thermal analysis (DTA) of a cured resin portion that is cut out. Moreover, with this configuration, since the conductor layer can be formed in a general laminating process for manufacturing the battery 1000, it is possible to realize the battery 1000 having high productivity. For example, the conductor layer can be formed by curing an applied film by heat treatment after printing or applying a paste resin for forming the conductor layer including a thermosetting resin. By applying the paste resin for forming the conductor layer onto the active material layer including an organic binder and curing the paste resin when the active material layer is soft (for example, has a high temperature and is soft) and cooling the paste resin to the room temperature, thermal expansion coefficient difference at the interface between the conductor layer and the active material layer can be absorbed. Thus, it is possible to bond the conductor layer and the active material layer while suppressing generation of a structural defect such as a crack or interfacial delamination.

The conductor layer may be a multilayer film. With this configuration, regarding a surface layer of the conductor layer in contact with the active material layer and regarding an internal layer of the conductor layer, it is possible to change each of: various properties such as hardness, density, thermal expansion coefficient, and thermal conductivity; type of material; curing conditions; and the like. For example, by appropriately selecting the properties, material, and the like regarding the surface layer of the conductor layer, it is possible to improve the adhesion of the bonding surface between the conductor layer and the active material layer. Thus, it is possible to realize a battery having high reliability. A surface layer forming a main surface of a multilayer film may be softer than an internal layer of the multilayer film. With this configuration, the soft surface layer of the conductor layer can absorb expansion and contraction of the active material layer caused by charging and discharging. Thus, the adhesion of the bonding surface between the conductor layer and the active material layer under a charge-discharge cycle is further improved, and therefore it possible to realize a battery having high reliability. The multilayer film may include a metal plate. The multilayer film may include, for example, a hard conductive plate such as a metal plate as an internal layer and may include a layer made of a soft resin material as a surface layer. The multilayer film may be, for example, a hard conductive plate whose surface is covered by a conductive resin.

The multilayer film may include a thermosetting resin, and the curing temperature of the material of a surface layer forming a main surface of the multilayer film may be lower than that of the material of an internal layer of the multilayer film. An internal layer of the conductor layer has a problem in that excessive thermal hysteresis is accumulated in a repetitive curing process of a multilayer film such as curing of a surface layer and the like, and generation of a crack, strength reduction, and the like due to deterioration of a resin component occur easily. However, as in the above configuration, when the material of a surface layer of the conductor layer has a curing temperature lower than that of the material of an internal layer, it is possible to form a conductor layer of the multilayer film while suppressing deterioration of a resin in an inner layer portion. Accordingly, a conductor layer having high bonding reliability with the active material layer can be formed. Thus, it is possible to obtain the battery 1000 having high reliability.

The material of the conductor layer may be appropriately selected in consideration of the following: resistance to decomposition or melting in a manufacturing process, at the operating temperature, and at the operating pressure; the operating electric potential of the battery 1000 applied to the conductor layer; the conductivity; and a stress due to expansion and contraction of the battery 1000. The conductor layer may be a multilayer film in which a plurality of layers made of materials whose compositions differ from each other are laminated, or a multilayer film in which a plurality of layers whose textures or structures (such as plate-shaped structures or mesh-shaped structures) differ from each other are laminated. It is possible to examine the structure of such a multilayer film by observing an ion-milled cross section by using a SEM or the like.

### Active Material Layer

The first active material layer 130 is, for example, a positive-electrode active material layer. The first active material layer 130 is sandwiched between the solid electrolyte layer 300, and the first current collector layer 110 and the first conductor layer 120. The first active material layer 130 may be in contact with the first current collector layer 110 and the first conductor layer 120. The first active material layer 130 may be in contact with the solid electrolyte layer 300.

The second active material layer 230 is, for example, a negative-electrode active material layer. The second active material layer 230 is sandwiched between the solid electrolyte layer 300, and the second current collector layer 210 and the second conductor layer 220. The second active material layer 230 may be in contact with the second current collector layer 210 and the second conductor layer 220. The second active material layer 230 may be in contact with the solid electrolyte layer 300.

The positive-electrode active material layer includes a positive-electrode active material.

The positive-electrode active material is a material in which metal ions such as lithium (Li) ions or magnesium (Mg) ions are inserted into or removed from a crystal structure at an electric potential higher than that of a negative electrode and oxidation or reduction is performed accordingly. The type of the positive electrode material can be appropriately selected in accordance with the type of the battery, and a known positive-electrode active material can be used.

The positive-electrode active material is, for example, a chemical compound including lithium and a transition metal element. The chemical compound is, for example, an oxide including lithium and a transition metal element or a phosphate compound including lithium and a transition metal element.

Examples of the oxide including lithium and a transition metal element include the following: a lithium-nickel composite oxide such as LiNiₓM₁₋ₓO₂ (where M is at least one selected from the group consisting of Co, Al, Mn, V, Cr, Mg, Ca, Ti, Zr, Nb, Mo, and W, and where 0<x≤1 is satisfied); a layered oxide such as lithium cobaltite (LiCoO₂) or lithium nickelate (LiNiO₂); and a lithium manganate having a spinel structure (such as LiMn₂O₄, Li₂MnO₃, or LiMnO₂).

An example of the phosphate compound including lithium and a transition metal element is lithium iron phosphate having an olivine structure (LiFePO₄).

As the positive-electrode active material, sulfur (S) or a sulfide such as lithium sulfide (Li₂S) may be used. In this case, particles of the positive-electrode active material may be coated with lithium niobate (LiNbO₃), or lithium niobate may be added to the particles.

As the positive-electrode active material, only one of these materials may be used, or a combination of two or more of these materials may be used.

In order to increase lithium-ion conductivity or electron conductivity, the positive-electrode active material layer may include, in addition to a positive-electrode active material, a material other than the positive-electrode active material. That is, the positive-electrode active material layer may be a composite layer. Examples of the material include the following: a solid electrolyte such as an inorganic-material-based solid electrolyte or a sulfide-based solid electrolyte; a conductive auxiliary material such as acetylene black; and a binder such as polyethylene oxide or polyvinylidene fluoride.

The positive-electrode active material layer may have, for example, a thickness that is greater than or equal to 5 μm and less than or equal to 300 μm.

The negative-electrode active material layer includes a negative-electrode active material.

The negative-electrode active material layer is a layer that is mainly made of a negative electrode material such as a negative-electrode active material.

The negative-electrode active material is a material in which metal ions such as lithium (Li) ions or magnesium (Mg) ions are inserted into or removed from a crystal structure at an electric potential lower than that of a positive electrode and oxidation or reduction is performed accordingly. The type of the negative electrode material can be appropriately selected in accordance with the type of the battery, and a known negative-electrode active material can be used.

Examples of the negative-electrode active material include the following: a carbon material such as natural graphite, synthetic graphite, graphite carbon fiber, or resin-baked carbon; and an alloy-based material mixed with a solid electrolyte. Examples of the alloy-based material include the following: a lithium alloy such as LiAl, LiZn, Li₃Bi, Li₃Cd, Li₃Sb, Li₄Si, Li_{4.4}Pb, Li_{4.4}Sn, Li_{0.17}C, or LiC₆; an oxide of lithium and a transition metal element such as lithium titanate (Li₄Ti₅O₁₂); and a metal oxide such as zinc oxide (ZnO) or silicon oxide (SiOₓ).

As the negative-electrode active material, only one of these materials may be used or a combination of two or more of these materials may be used.

In order to increase lithium-ion conductivity or electron conductivity, the negative-electrode active material layer may include, in addition to a negative-electrode active material, a material other than the negative-electrode active material. Examples of the material include the following: a solid electrolyte such as an inorganic-material-based solid electrolyte or a sulfide-based solid electrolyte; a conductive auxiliary material such as acetylene black; and a binder such as polyethylene oxide or polyvinylidene fluoride.

The negative-electrode active material layer may have, for example, a thickness that is greater than or equal to 5 μm and less than or equal to 300 μm.

As illustrated in FIG. 1(b), the active material layer has a rectangular shape in plan view, but this is not a limitation. It is sufficient that the active material layer include a portion that is in contact with the current collector layer, and the active material layer may have a circular shape or an elliptical shape.

### Solid Electrolyte Layer

The solid electrolyte layer 300 includes a solid electrolyte.

The solid electrolyte layer 300 includes, for example, a solid electrolyte as a main component. Here, “main component” refers to a component whose mass percentage is the highest among the components of the solid electrolyte layer 300. The solid electrolyte layer 300 may include only a solid electrolyte.

The solid electrolyte may be a known ion-conductive solid electrolyte for a battery. As the solid electrolyte included in the solid electrolyte layer 300, for example, a solid electrolyte that conducts metal ions such as lithium ions or magnesium ions can be used.

As the solid electrolyte, a sulfide solid electrolyte, an oxide solid electrolyte, or a halide solid electrolyte can be used.

The sulfide-based solid electrolyte is, for example, Li₂S—P₂S₅-based, Li₂S—SiS₂-based, Li₂S—B₂S₃-based, Li₂S—GeS₂-based, Li₂S—SiS₂—LiI-based, Li₂S—SiS₂—Li₃PO₄-based, Li₂S—Ge₂S₂-based, Li₂S—GeS₂—P₂S₅-based, or Li₂S—GeS₂—ZnS-based.

The oxide-based solid electrolyte is, for example, a lithium-containing metal oxide, a lithium-containing metal nitride, lithium phosphate (Li₃PO₄), or a lithium-containing transition-metal oxide. An example of the lithium-containing metal oxide is Li₂O—SiO₂ or Li₂O—SiO₂—P₂O₅. An example of the lithium-containing metal nitride is LixPyO_{1-z}N_{z} (0<z≤1). An example of the lithium-containing transition-metal oxide is a lithium-titanium oxide.

The halide solid electrolyte is, for example, a compound including Li, M, and X. Here, M is at least one selected from the group consisting of metallic elements other than Li and metalloid elements. X is at least one selected from the group consisting of F, Cl, Br, and I.

The “metalloid elements” are B, Si, Ge, As, Sb, and Te. The “metallic elements” are all elements included in the groups 1 to 12 of the periodic table (excluding hydrogen) and all elements included in the groups 13 to 16 of the periodic table (excluding B, Si, Ge, As, Sb, Te, C, N, P, O, S, and Se).

In order to improve the ion conductivity of the halide solid electrolyte, M may include Y. M may be Y.

The halide solid electrolyte may be, for example, a compound represented as LiₐMe_{b}Y_{c}X₆. Here, mathematical expressions a+mb+3c=6 and c>0 are satisfied. The value of m represents the valence of Me.

In order to improve the ion conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

In order to improve the ion conductivity of the halide solid electrolyte, X may include at least one selected from the group consisting of Cl and Br.

The halide solid electrolyte may include, for example, at least one selected from the group consisting of Li₃YCl₆ and Li₃YBr₆.

As the solid electrolyte, only one of these materials may be used, or a combination of two or more of these materials may be used.

The solid electrolyte layer 300 may include, in addition to the solid electrolyte, a binder such as polyethylene oxide or polyvinylidene fluoride.

The thickness of the solid electrolyte layer 300 may be greater than or equal to 5 μm and less than or equal to 500 μm, may be greater than or equal to 10 μm and less than or equal to 500 μm, or may be greater than or equal to 5 μm and less than or equal to 150 μm.

The material of the solid electrolyte may be composed of aggregates of particles. Alternatively, the material of the solid electrolyte may be composed of sintered structures.

### Side-Surface Insulating Layer

It is sufficient that the side-surface insulating layer be made of a material having insulating properties. For example, an insulating resin, an insulating oxide, or the like can be used. Examples of the insulating resin include an epoxy resin, a silicone resin, and a fluorocarbon resin. Examples of the insulating oxide include an aluminum oxide, a zirconium oxide, a titanium oxide, and a silicon oxide.

The side-surface insulating layer may include, for example, a resin. With this configuration, the elasticity, that is, the softness of the side-surface insulating layer can absorb deformation of a side-surface portion of the battery 1000, which expands and contracts due to charging and discharging operations. Accordingly, it is possible to suppress peeling of the side-surface insulating layer from the laminated body composed of the first active material layer 130, the solid electrolyte layer 300, and the second active material layer 230, that is, peeling of the side-surface insulating layer from the active material layer and the solid electrolyte layer, which are constituent members of the battery element. For example, a layer that is softer than the constituent members of the battery element is suitable for the side-surface insulating layer. Moreover, due to the sealing properties of the resin material, the side-surface insulating layer can suppress entry of water and a gas component that deteriorates the battery characteristics into the battery. Moreover, since the side-surface insulating layer, in which the resin material is used, can absorb a stress difference at the bonding interface between the side-surface insulating layer and the lead-out conductor member disposed on a surface of the side-surface insulating layer, it is possible to suppress delamination at the interface between the side-surface insulating layer and the lead-out conductor member.

The side-surface insulating layer may include, for example, a thermosetting resin. With this configuration, it is possible to form the side-surface insulating layer by using a method of applying a terminal electrode, which is a so-called edge coating method, or the like that is generally used to manufacture a chip component such as a multilayer ceramic capacitor (MLCC). Accordingly, it is possible to realize the battery 1000 having high productivity and high reliability. In a case where a laminated body composed of the first active material layer 130, the solid electrolyte layer 300, and the second active material layer 230 includes an organic binder, by applying a paste resin for forming the side-surface insulating layer to a side surface of the laminated body including the organic binder and curing the paste resin when the side surface of the laminated body is soft (for example, has a high temperature and is soft) and cooling the paste resin to the room temperature, thermal expansion coefficient difference at the interface between the side-surface insulating layer and the side surface of the laminated body can be absorbed. Thus, it is possible to bond the side-surface insulating layer and the side surface of the laminated body while suppressing generation of a structural defect such as a crack or interfacial delamination.

The side-surface insulating layer may be a multilayer film. With this configuration, regarding the bonding surface between the side-surface insulating layer and a side surface of the laminated body composed of the first active material layer 130, the solid electrolyte layer 300, and the second active material layer 230, and regarding the bonding surface between the side-surface insulating layer and the lead-out conductor member, it is possible to change each of: various properties such as hardness, density, thermal expansion coefficient, and thermal conductivity; type of material; curing conditions; and the like. Thus, it is possible to improve the adhesion between the side-surface insulating layer, the side surface of the laminated body, and the lead-out conductor member. Therefore, the bonding reliability of the side-surface insulating layer against a charge-discharge cycle and an external stress is increased. Moreover, it is possible to use a layer having high density and high sealing properties (such as watertightness and gas-tightness) as an internal layer of the side-surface insulating layer. To be specific, for example, an alumina plate, an aluminum laminate film, or the like having high density may be inserted into an internal layer portion. Thus, entry of water or a gas component that deteriorates the battery characteristics into the battery through an interlayer gap in a battery side surface can be suppressed, and it is possible to realize a battery having high reliability. A surface layer forming a main surface of a multilayer film as the side-surface insulating layer may be softer than an internal layer of the multilayer film. With this configuration, the soft surface layer of the side-surface insulating layer can absorb a stress that is generated at the bonding surface with the lead-out conductor member due to expansion and contraction of the battery caused by charging and discharging. Thus, the adhesion between the side-surface insulating layer and the lead-out conductor member under a charge-discharge cycle is further improved and interfacial delamination is suppressed, and therefore it is possible to realize a battery having high reliability.

The multilayer film as the side-surface insulating layer may include a thermosetting resin. For example, when the first electrode layer 100 further includes a first insulating layer (not shown) and the second electrode layer 200 further includes a second insulating layer (not shown), the curing temperature of a thermosetting resin included in the multilayer film may be lower than the curing temperature of a thermosetting resin included in the first insulating layer and the second insulating layer, and the curing temperature of the material of a surface layer forming a main surface of the multilayer film may be lower than the curing temperature of the material of an internal layer of the multilayer film. The first insulating layer is disposed at a position that is on the first main surface 130a of the first active material layer 130 and that is adjacent to the second side surface 1000b of the battery 1000. The second insulating layer is disposed at a position that is on the first main surface 230a of the second active material layer 230 and that is adjacent to the first side surface 1000a of the battery 1000. Details of the first insulating layer and the second insulating layer will be described below in the second embodiment. The first insulating layer, the second insulating layer, and the side-surface insulating layer have a problem in that excessive thermal hysteresis is accumulated in a repetitive curing process, and generation of a crack, strength reduction, and the like due to deterioration of a resin component occur easily. However, as in the above configuration, when the curing temperature of a thermosetting resin included in the multilayer film of the side-surface insulating layer is lower than the curing temperature of a thermosetting resin included in the first insulating layer and the second insulating layer and the curing temperature of the material of a surface layer of the multilayer film of the side-surface insulating layer is lower than the curing temperature of the material of an internal layer, it is possible to form the first insulating layer, the second insulating layer, and the side-surface insulating layer while suppressing accumulation of excessive thermal hysteresis and suppressing resin deterioration. Thus, it is possible to suppress generation of a crack and strength reduction in the first insulating layer, the second insulating layer, and the side-surface insulating layer. Accordingly, it is possible to obtain a battery having higher reliability. Moreover, with this configuration, it is possible to selectively make the surface layer of the side-surface insulating layer softer than the internal layer.

When the side-surface insulating layer includes a thermosetting resin, the side-surface insulating layer may be formed by using a thermosetting insulating resin paste. Such a forming method allows an application thickness to be easily controlled and also has high productivity. The side-surface insulating layer may be a multilayer film in which a plurality of layers made of materials whose compositions differ from each other are laminated, or a multilayer film in which a plurality of layers whose textures or structures (such as plate-shaped structures or mesh-shaped structures) differ from each other are laminated. It is possible to examine the structure of such a multilayer film by observing an ion-milled cross section by using a SEM or the like.

The thickness of the side-surface insulating layer is, for example, greater than or equal to 5 μm and less than or equal to 300 μm, but the thickness is not limited to this. The thickness of the side-surface insulating layer may be appropriately set so that a lead-out conductor member formed on the side-surface insulating layer does not enter a hole included in the side-surface insulating layer and reach the active material layer and the solid electrolyte.

### Lead-Out Conductor Member

It is sufficient that the lead-out conductor member be made of a conductor material, and is desirably made of, for example, a material having high conductivity.

The lead-out conductor member may include, for example, a resin. With this configuration, the elasticity, that is, the softness of the lead-out conductor member can absorb deformation of a side-surface portion of the battery 1000, which expands and contracts due to charging and discharging operations. Accordingly, for example, when at least a part of the lead-out conductor member is disposed on a surface of the side-surface insulating layer, it is possible to suppress peeling of the lead-out conductor member from the side-surface insulating layer. Moreover, due to the sealing properties of a resin material, the lead-out conductor member can suppress entry of water and a gas component that deteriorates the battery characteristics into the battery, and therefore it is possible to obtain a battery having high reliability.

The lead-out conductor member may be a multilayer film. With this configuration, for example, when at least a part of the lead-out conductor member is disposed on a surface of the side-surface insulating layer, in the lead-out conductor member, regarding a surface in contact with the side-surface insulating layer and regarding a surface in contact with a lead terminal, a mount substrate, and the like, it is possible to change each of: various properties such as hardness, density, thermal expansion coefficient, and thermal conductivity; type of material; curing conditions; and the like. Thus, it is possible to improve the adhesion between the lead-out conductor member and the side-surface insulating layer, the lead terminal, and the like. Therefore, the bonding reliability of the lead-out conductor member against a charge-discharge cycle and an external stress is increased. Moreover, it is also possible to use a layer having high density and high sealing properties (such as watertightness and gas-tightness) as an internal layer of the lead-out conductor member. Thus, entry of water or a gas component that deteriorates the battery characteristics into the battery through an interlayer gap in the battery side surface can be suppressed, and it is possible to realize the battery 1000 having high reliability. A surface layer forming a main surface of the multilayer film as the lead-out conductor member may be softer than an internal layer of the multilayer film. With this configuration, the soft surface layer of the lead-out conductor member can absorb a stress that is generated, due to expansion and contraction of the battery caused by charging and discharging, at the bonding surface between the lead-out conductor member and the side-surface insulating layer and at the bonding surface between the lead-out conductor member and a lead terminal connected to an external circuit, a mounting substrate, or the like. Thus, the adhesion between the lead-out conductor member and the side-surface insulating layer, the lead terminal, and the like under a charge-discharge cycle and under an external stress is further improved and interfacial delamination in the lead-out conductor member is suppressed, and therefore it is possible to realize a battery having high reliability.

The multilayer film as the lead-out conductor member may include a thermosetting resin. In this case, the curing temperature of a thermosetting resin included in the multilayer film may be lower than the curing temperature of a thermosetting resin included in the first-side-surface insulating layer and the second-side-surface insulating layer, and the curing temperature of the material of the surface layer forming a main surface of a multilayer film may be lower than the curing temperature of the material of an internal layer of the multilayer film. The side-surface insulating layer and the lead-out conductor member have a problem in that excessive thermal hysteresis is accumulated in a repetitive curing process, and generation of a crack, strength reduction, and the like due to deterioration of a resin component occur easily. However, as in the above configuration, when the curing temperature of a thermosetting resin included in the multilayer film of the lead-out conductor member is lower than the curing temperature of a thermosetting resin included in the first-side-surface insulating layer and the second-side-surface insulating layer and the curing temperature of the material of a surface layer of the multilayer film of the lead-out conductor member is lower than the curing temperature of the material of an internal layer, it is possible to form the side-surface insulating layer and the lead-out conductor member while suppressing accumulation of excessive thermal hysteresis and suppressing resin deterioration. Thus, it is possible to suppress generation of a crack and strength reduction in the side-surface insulating layer and the lead-out conductor member. Accordingly, it is possible to obtain a battery having higher reliability. Moreover, with this configuration, it is possible to selectively make the surface layer of the lead-out conductor member softer than the internal layer.

When the lead-out conductor member includes a thermosetting resin, the lead-out conductor member may be made of a thermosetting conductive resin including metal particles and a thermosetting resin. As the metal particles, for example, metal particles having high conductivity, such as Ag particles or Cu particles, are desirable. In this case, the lead-out conductor member can be formed by a general application process such as screen printing or transfer printing. As the material of the lead-out conductor member, any of the materials described above as the material of the conductor layer can be used. The lead-out conductor member may be a multilayer film in which a plurality of layers made of materials whose compositions differ from each other are laminated, or a multilayer film in which a plurality of layers whose textures or structures differ from each other (such as plate-shaped structures or mesh-shaped structures) are laminated. The material of the lead-out conductor member can be selected in accordance with the following: resistance to decomposition or melting in a manufacturing process, at the operating temperature, and at the operating pressure; and required tensile strength and heat resistance.

The thickness of the lead-out conductor member is greater than or equal to 5 μm and less than or equal to 300 μm, but the thickness is not limited to this. It is desirable to set the thickness of the lead-out conductor member to an appropriate thickness in consideration of reduction of manufacturing cost, suppression of a crack that may be generated in a thermal cycle, and the like.

The lead-out conductor member may include a metal plating film provided on a surface thereof. With this configuration, it is possible to connect the battery 1000 according to the first embodiment to a lead terminal, a mount substrate, or the like by solder mounting by reflow soldering or the like or by solder connection. Accordingly, it is possible to connect the battery 1000 according to the first embodiment to an external circuit with a small resistance loss and high reliability in mechanical strength. Moreover, watertightness and gas-tightness are improved due to the sealability of the metal plating film, and therefore it is possible to obtain a battery having high reliability in an actual use environment.

With the battery 1000 according to the first embodiment having the configuration described above, when a laminated battery is to be formed by laminating a plurality of batteries 1000, it is possible to form an assembled battery having an integrated structure without using lead wires that may break easily. It is possible to select whether to laminate the plurality of batteries 1000 to be connected in parallel or in series. Accordingly, with the battery 1000 according to the first embodiment, it is possible to realize a small high-capacity battery while realizing high reliability.

The configuration of the battery 1000 according to the first embodiment differs from the configuration of the batteries described in Japanese Unexamined Patent Application Publication No. 2021-57322 and International Publication No. 2018/087970 in the following respects.

Japanese Unexamined Patent Application Publication No. 2021-57322 discloses a laminated battery having a structure such that a current collector layer, which is interposed between a plurality of power generation elements to allow the power generation elements to be laminated, and an insulating layer made of an insulating adhesive are disposed on the same plane. However, a conductor layer that is formed on the same plane as the current collector layer is not provided. Accordingly, the battery disclosed in Japanese Unexamined Patent Application Publication No. 2021-57322 differs from the battery 1000 according to the first embodiment, which has a configuration such that a current collector layer and a lead-out conductor member are strongly connected to each other with low resistance via a conductor layer that is provided, on an active material layer, on the same plane as the current collector layer.

International Publication No. 2018/087970 discloses a laminated battery having a structure such that an insulating layer is formed on a side surface of a laminated body including a current collector layer and an electrode layer. However, a conductor layer that is formed on the same plane as the current collector layer is not provided. Accordingly, the battery disclosed in International Publication No. 2018/087970 differs from the battery 1000 according to the first embodiment, which has a configuration such that a current collector layer and a lead-out conductor member are strongly connected to each other with low resistance via a conductor layer that is provided, on an active material layer, on the same plane as the current collector layer.

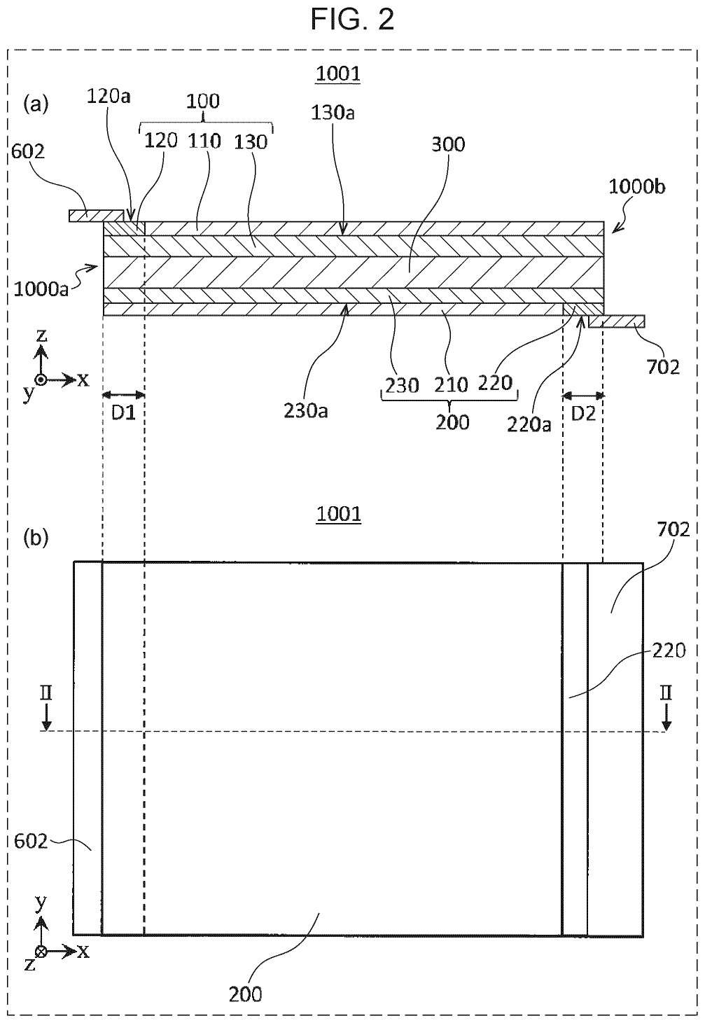

As described above, in the battery 1000, the first lead-out conductor member and the second lead-out conductor member need not be disposed along the side surfaces of the battery. In this case, the first-side-surface insulating layer and the second-side-surface insulating layer may be omitted. FIG. 2 illustrates a sectional view and a plan view illustrating the schematic configuration of a battery according to a modification of the first embodiment. FIG. 2(a) is a sectional view of a battery 1001 according to the modification. FIG. 2(b) is a plan view of the battery 1001 according to the modification as seen from below in the z-axis direction. FIG. 2(a) is a sectional view taken along a dotted line II-II of FIG. 2(b). In the battery 1001 according to the modification of the first embodiment, a first lead-out conductor member 602 and a second lead-out conductor member 702 may extend, for example, toward the outer side of the battery 1001 as illustrated in FIG. 2.

### Second Embodiment

Hereafter, a battery according to a second embodiment will be described. The matters described in the first embodiment may be omitted as appropriate.

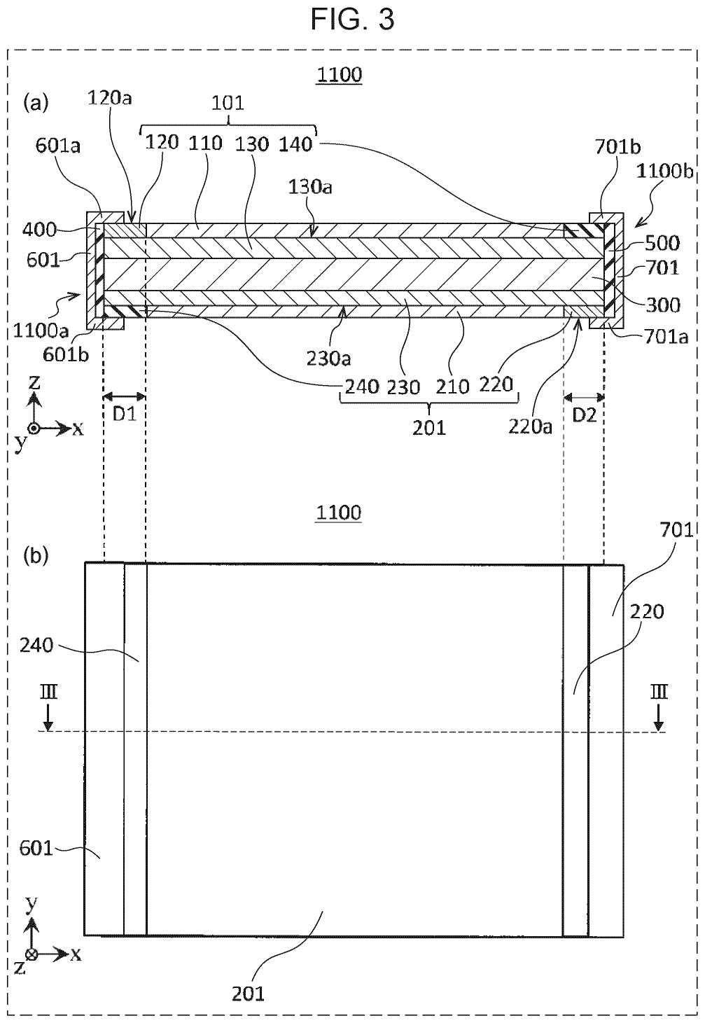

FIG. 3 illustrates a sectional view and a plan view illustrating the schematic configuration of a battery 1100 according to the second embodiment.

FIG. 3(a) is a sectional view of the battery 1100 according to the second embodiment. FIG. 3(b) is a plan view of the battery 1100 according to the second embodiment as seen from below in the z-axis direction. FIG. 3(a) is a sectional view taken along a dotted line III-III of FIG. 3(b).

As illustrated in FIG. 3, the battery 1100 according to the second embodiment has a configuration such that, in the battery 1000 according to the first embodiment, a first insulating layer 140 and a second insulating layer 240 are further provided.

A first electrode layer 101 further includes the first insulating layer 140, in addition to the first current collector layer 110, the first conductor layer 120, and the first active material layer 130. The first insulating layer 140 is disposed at a position that is on the first main surface 130a of the first active material layer 130 and that is adjacent to a second side surface 1100b of the battery 1100.

A second electrode layer 201 further includes the second insulating layer 240 in addition to the second current collector layer 210, the second conductor layer 220, and the second active material layer 230. The second insulating layer 240 is disposed at a position that is on the first main surface 230a of the second active material layer 230 and that is adjacent to a first side surface 1100a of the battery 1100.

In this way, since the first insulating layer 140, which is disposed at a position that is on the first main surface 130a of the first active material layer 130 and that is adjacent to the second side surface 1100b of the battery 1100, is provided, the first electrode layer 101 can be strongly bonded to the second-side-surface insulating layer 500. Accordingly, it is possible to suppress a problem in that the second-side-surface insulating layer 500 is easily peeled from the second side surface of the laminated body composed of the first active material layer 130, the solid electrolyte layer 300, and the second active material layer 230 due to deformation caused by charging and discharging of the battery 1100 or the like. Likewise, since the second insulating layer 240 is provided, it is possible to suppress a problem in that the first-side-surface insulating layer 400 is easily peeled from the first side surface of the laminated body composed of the first active material layer 130, the solid electrolyte layer 300, and the second active material layer 230 due to deformation caused by charging and discharging of the battery 1100 or the like. Accordingly, it is possible to realize the battery 1100 with which deterioration of characteristics due to a short circuit or a structural defect is suppressed and that has higher reliability.

Since the second insulating layer 240 is provided, a first lead-out conductor member 601 may include a wraparound portion 601b that is continuous from the first side surface 1100a of the battery 1100 onto a first main surface 240a of the second insulating layer 240 that does not face the second active material layer 230, and the first lead-out conductor member 601 may be in contact with the second insulating layer 240 at the first main surface 240a of the second insulating layer 240. Likewise, since the first insulating layer 140 is provided, a second lead-out conductor member 701 may include a wraparound portion 701b that is continuous from the second side surface 1100b the battery 1100 onto a first main surface 140a of the first insulating layer 140 that does not face the first active material layer 130, and the second lead-out conductor member 701 may be in contact with the first insulating layer 140 at the first main surface 140a of the first insulating layer 140. Note that the first lead-out conductor member 601 may have a configuration similar to that of the wraparound portion 600a of the first lead-out conductor member 600 described in the first embodiment, that is, the first lead-out conductor member 601 may include a wraparound portion 601a that is continuous from the first side surface 1100a of the battery 1100 onto the first main surface 120a of the first conductor layer 120 that does not face the first active material layer 130. Moreover, the second lead-out conductor member 701 may have a configuration similar to that of the wraparound portion 700a of the second lead-out conductor member 700 described in the first embodiment, that is, the second lead-out conductor member 701 may include a wraparound portion 701a that is continuous from the second side surface 1100b of the battery 1100 onto the first main surface 220a of the second conductor layer 220 that does not face the second active material layer 230. Due to such a configuration, with the battery 1100 according to the second embodiment, it is possible to more reliably suppress peeling of the first lead-out conductor member 601 and the second lead-out conductor member 701 from the side-surface insulating layer.

In the second embodiment, both of the first insulating layer 140 and the second insulating layer 240 are provided. However, only one of these may be provided. That is, the battery 1100 according to the second embodiment satisfies, for example, at least one selected from the group consisting of (A-2) and (B-2): (A-2) The first electrode layer 101 further includes the first insulating layer 140 disposed at a position that is on the first main surface 130a of the first active material layer 130 and that is adjacent to the second side surface 1100b of the battery 1100.; and (B-2) The second electrode layer 201 further includes the second insulating layer 240 disposed at a position that is on the first main surface 230a of the second active material layer 230 and that is adjacent to the first side surface 1100a of the battery 1100.

In the present specification, the first insulating layer 140 and the second insulating layer 240 may be collectively and simply referred to as “insulating layer”.

It is sufficient that the insulating layer be made of a material having insulating properties. For example, an insulating resin, an insulating oxide, or the like can be used. Examples of the insulating resin include an epoxy resin, a silicone resin, and a fluorocarbon resin. Examples of the insulating oxide include an aluminum oxide, a zirconium oxide, a titanium oxide, and a silicon oxide.

The insulating layer may include, for example, a resin. With this configuration, since the elasticity of the resin, that is, the softness of the resin can absorb expansion and contraction of the active material caused by charging and discharging, the adhesion of the bonding surface between the insulating layer and the active material layer and the adhesion of the bonding surface between the insulating layer and the side-surface insulating layer and the lead-out conductor member can be maintained. Accordingly, it is possible to realize a battery having excellent charge-discharge cycle characteristics, because the lead-out conductor member, the side-surface insulating layer, the insulating layer, and the active material layer are strongly connected.

The insulating layer may include, for example, a thermosetting resin. With this configuration, since the insulating layer can be formed in a general laminating process for manufacturing the battery 1100, it is possible to realize the battery 1100 having high productivity. For example, the insulating layer can be formed by curing an applied film by heat treatment after printing or applying a paste resin for forming the insulating layer including a thermosetting resin. By applying the paste resin for forming the insulating layer onto the active material layer including an organic binder and curing the paste resin when the active material layer is soft (for example, has a high temperature and is soft) and cooling the paste resin to the room temperature, thermal expansion coefficient difference at the interface between the insulating layer and the active material layer can be absorbed. Thus, it is possible to bond the insulating layer and the active material layer while suppressing generation of a structural defect such as a crack or interfacial delamination.

For example, when the insulating layer is to be made from a thermosetting resin such as an epoxy resin, the insulating layer can be formed by applying the thermosetting resin by using a general method, such as screen printing, and curing the applied film. When the thermosetting resin is used, the thermosetting resin is applied when the active material layer including an organic binder is soft (for example, is at a high temperature and soft), and the applied film is cured. Therefore, without allowing a crack to be formed at the interface with the active material layer and in the active material layer, it is possible to form the insulating layer along the main surface of the active material layer to follow the shape of the main surface and to be in close contact with the main surface. Moreover, since a soft resin component of the insulating layer formed on the active material layer can absorb deformation of the battery 1100, for example, the active material layer, the reliability of the bonding surface between the insulating layer and the active material layer can be easily maintained, and interfacial delamination is suppressed.

The insulating layer may be a multilayer film. With this configuration, regarding a surface layer of the insulating layer in contact with the active material layer and regarding an internal layer of the insulating layer, it is possible to change each of: various properties such as hardness, density, thermal expansion coefficient, and thermal conductivity; type of material; curing conditions; and the like. For example, by appropriately selecting the properties, material, and the like regarding the surface layer of the insulating layer, it is possible to improve the adhesion of the bonding surface between the insulating layer and the active material layer. Moreover, it is possible to use a layer having high density and high sealing properties (such as watertightness and gas-tightness) as an internal layer of the insulating layer. To be specific, for example, an alumina plate, an aluminum laminate film, or the like having high density may be inserted into an internal layer portion. Thus, for example, with the insulating layer, while suppressing peeling from the active material layer, entry of water or a gas component that deteriorates the battery characteristics into the battery can be suppressed, and it is possible to realize a battery having high reliability. A multilayer film may be formed by repeating application and curing of an applied film while changing the resin material and changing the curing temperature. By using a rigid plate-shaped insulator, a multilayer film may be formed as a complex of the plate-shaped insulator and a resin material. A surface layer forming a main surface of a multilayer film as the insulating layer may be softer than an internal layer of the multilayer film. With this configuration, the soft surface layer of the insulating layer can absorb expansion and contraction of the active material layer caused by charging and discharging. Thus, the adhesion of the bonding surface between the insulating layer and the active material layer under a charge-discharge cycle is further improved, and therefore it is possible to realize the battery 1100 having high reliability.

The multilayer film as the insulating layer may include a thermosetting resin. In this case, the curing temperature of the material of a surface layer forming a main surface of the multilayer film may be lower than that of the material of an internal layer of the multilayer film. An internal layer of the insulating layer has a problem in that excessive thermal hysteresis is accumulated in a repetitive curing process of a multilayer film such as curing of a surface layer and the like, and generation of a crack, strength reduction, and the like due to deterioration of a resin component occur easily. However, as in the above configuration, when the material of a surface layer of the insulating layer has a curing temperature lower than that of the material of an internal layer, it is possible to form an insulating layer of a multilayer film while suppressing deterioration of a resin in an inner layer portion. Accordingly, an insulating layer having high bonding reliability with the active material layer can be formed. Thus, it is possible to obtain the battery 1100 having high reliability.

The insulating layer may be a plate-shaped member including an inorganic material. With this configuration, since a side-surface portion of the battery 1100, which may easily break due to an external impact, can be reinforced by a plate-shaped member including an inorganic material that is more rigid than the active material layer and the solid electrolyte layer, which are constituent members of a battery element, it is possible to realize the battery 1100 having high mechanical reliability.

In the battery 1100 illustrated in FIG. 3, the first-side-surface insulating layer 400 and the second-side-surface insulating layer 500 are formed on the side surfaces of the first electrode layer 100, the solid electrolyte layer 300, and the second electrode layer 200. However, regions in which the first-side-surface insulating layer 400 and the second-side-surface insulating layer 500 are disposed are not limited to these. For example, the side surfaces of the first conductor layer 120 and the second insulating layer 240 need not be covered by the first-side-surface insulating layer 400, and the side surfaces of the second conductor layer 220 and the first insulating layer 140 need not be covered by the second-side-surface insulating layer 500.

### Third Embodiment

Hereafter, a battery according to a third embodiment will be described. The matters described in the above embodiments may be omitted as appropriate.

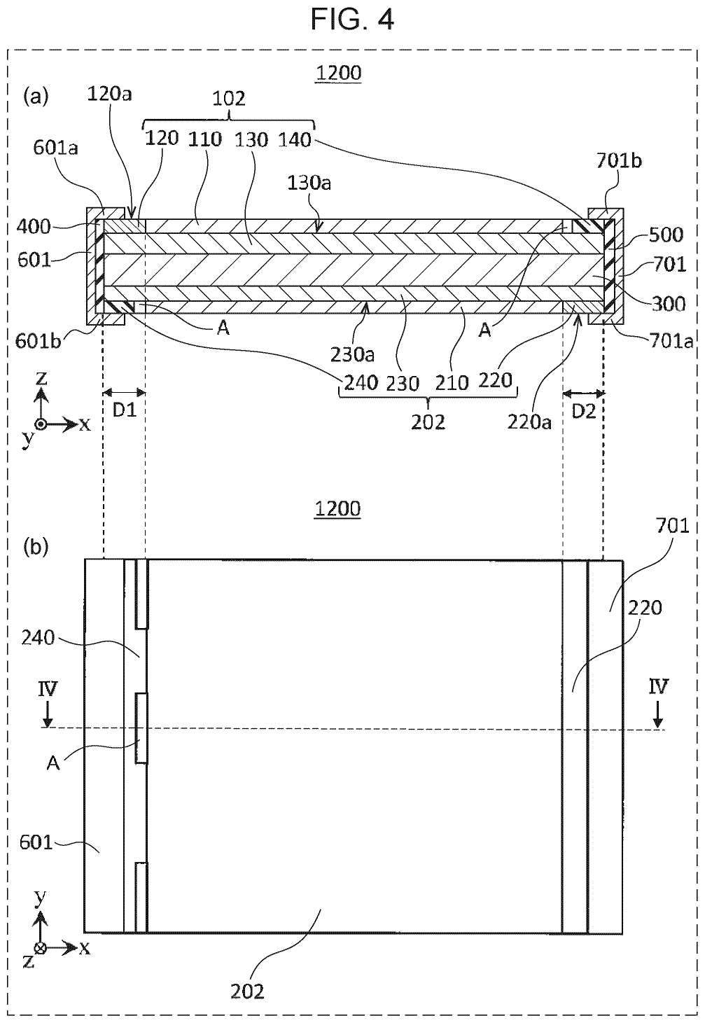

FIG. 4 illustrates a sectional view and a plan view illustrating the schematic configuration of a battery 1200 according to the third embodiment.

FIG. 4(a) is a sectional view of the battery 1200 according to the third embodiment. FIG. 4(b) is a plan view of the battery 1200 according to the third embodiment as seen from below in the z-axis direction. FIG. 4(a) illustrates a cross section taken along line IV-IV of FIG. 4(b).

The battery 1200 according to the third embodiment differs from the battery 1100 according to the second embodiment in the configurations of the first electrode layer and the second electrode layer. A first electrode layer 102 of the battery 1200 has a configuration such that, in the first electrode layer 101 of the battery 1100 according to the second embodiment, a gap A is provided between the first current collector layer 110 and the first insulating layer 140. Moreover, a second electrode layer 202 of the battery 1200 has a configuration such that, in the second electrode layer 201 of the battery 1100 according to the second embodiment, a gap A is provided between the second current collector layer 210 and the second insulating layer 240. The first current collector layer 110 and the first insulating layer 140 have portions that are not in contact with each other at side surfaces thereof. The second current collector layer 210 and the second insulating layer 240 have portions that are not in contact with each other at side surfaces thereof. As illustrated in FIG. 4(b), three gaps A are provided between the first current collector layer 110 and the first insulating layer 140, and three gaps A are provided between the second current collector layer 210 and the second insulating layer 240. However, the number of the gap(s) A is not particularly limited.

As described above, since the gap A is provided in the battery 1200 according to the third embodiment, the gap A serves as an absorber of a stress that is generated due to the difference in thermal expansion coefficient between the first current collector layer 110 and the first insulating layer 140 when temperature changes in a thermal cycle or the like, and a structural defect such as warping or breakage (such as cracking) of the battery 1200 can be suppressed. The gap A may be partially provided in at least a part of side surfaces of the first current collector layer 110 and the first insulating layer 140. Likewise, the gap A in the second electrode layer 202 also serves as an absorber of a stress that is generated due to the difference in thermal expansion coefficient between the second current collector layer 210 and the second insulating layer 240 when temperature changes in a thermal cycle or the like, and a structural defect of the battery 1200 can be suppressed. The gap A may be partially provided in at least a part of side surfaces of the second current collector layer 210 and the second insulating layer 240. The number and the size of the gap(s) A between the second current collector layer 210 and the second insulating layer 240 may be different from those of the gap(s) A in the first electrode layer 102. Two or more gaps A may be provided, or the gap A may be continuously formed instead of being formed partially. The expression “the gap A is continuously formed” means a configuration such that the current collector layer and the insulating layer are not in contact with each other.

For example, depending on the difference between active materials, thermal expansion coefficient and the like of the active material layer differs. Accordingly, the shape of the gap A may differ between the first electrode layer 102 and the second electrode layer 202. By adjusting the number of the gap(s) and the shape of the gap(s), a structural defect of the battery 1200 such as warping can be suppressed. By providing, for example, a gap A greater than or equal to the expansion value of the first current collector layer 110 and the second current collector layer 210, each of which has a relatively large thermal expansion coefficient among the constituent members of the battery 1200 in a temperature range in which the battery 1200 is used, the gap A can absorb extension of the current collector layer under a high-temperature use environment. Thus, it is possible to realize the battery 1200 having high reliability with which a structural defect such as warping is suppressed. By increasing the number of the gaps and the width of the gaps, the absorbability of thermal expansion coefficient difference is increased. However, when the number of gaps is increased excessively, decrease of mechanical strength may occur. Accordingly, the number of gaps and the like are appropriately adjusted. In order to suppress decrease of mechanical strength due to the gap, the bonding portion between the insulating layer and the current collector layer may have a combination of a curved structure or a zig-zag structure, with which high bending strength can be obtained.

### Fourth Embodiment

Hereafter, a battery according to a fourth embodiment will be described. The matters described in the above embodiments may be omitted as appropriate.

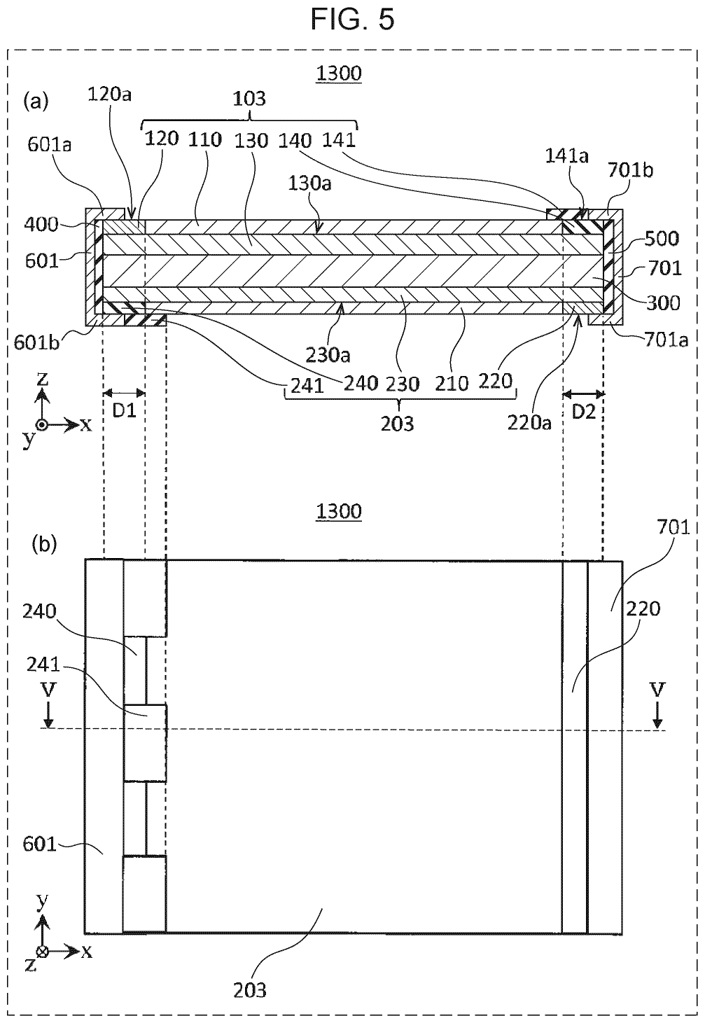

FIG. 5 illustrates a sectional view and a plan view illustrating the schematic configuration of a battery 1300 according to the fourth embodiment.

FIG. 5(a) is a sectional view of the battery 1300 according to the fourth embodiment. FIG. 5(b) is a plan view of the battery 1300 according to the fourth embodiment as seen from below in the z-axis direction. FIG. 5(a) illustrates a cross section taken along line V-V of FIG. 5(b).

As illustrated in FIG. 5, the battery 1300 further includes, in the configuration of the battery 1100 according to the second embodiment, a first covering insulating layer 141 that is disposed on both of the first main surface 140a of the first insulating layer 140 and a first main surface 110a of the first current collector layer 110, and a second covering insulating layer 241 that is disposed on both of the first main surface 240a of the second insulating layer 240 and a first main surface 210a of the second current collector layer 210. That is, the battery 1300 includes a first electrode layer 103 including the first current collector layer 110, the first conductor layer 120, the first active material layer 130, the first insulating layer 140, and the first covering insulating layer 141. Moreover, the battery 1300 includes a second electrode layer 203 including the second current collector layer 210, the second conductor layer 220, the second active material layer 230, the second insulating layer 240, and the second covering insulating layer 241.

In the present specification, the first covering insulating layer 141 and the second covering insulating layer 241 may be collectively and simply referred to as “covering insulating layer”.

The battery 1300 according to the fourth embodiment, which includes the covering insulating layer, can alleviate a problem in that the bonding portion between the current collector layer and the insulating layer is easily bent by an external stress. Moreover, it is possible to suppress a problem in that a foreign substance (such as water, gas, a metal dust that may cause a short circuit, or the like) enters the bonding portion between the current collector layer and the insulating layer and deteriorates the battery characteristics.

The form of the covering insulating layer is not particularly limited. For example, by making the length of the overlapping portion of the covering insulating layer and the current collector layer greater than or equal to the thickness of the current collector layer from an end surface on the first main surface of the current collector layer, it is possible to further improve the bending resistance at the bonding portion between the current collector layer and the insulating layer. The thickness of the covering insulating layer can be set to any appropriate thickness. A part of the covering insulating layer may be embedded in the first main surface of the current collector layer. The thickness of the embedded part of the covering insulating layer, which depends on the thickness of the current collector layer, may be, for example, greater than or equal to 0.3 μm and less than or equal to 5 μm. Thus, the bondability between the covering insulating layer and the current collector layer is improved, and the bending resistance at the bonding portion between the current collector layer and the insulating layer of the battery 1300 is further improved.

With the above configuration, bending of the battery 1300 due to an external stress or the like is suppressed, and thus deterioration of the characteristics of the battery 1300 can be suppressed. Accordingly, it is possible to provide the battery 1300 having higher reliability.

### Fifth Embodiment

Hereafter, a battery according to a fifth embodiment will be described. The matters described in the above embodiments may be omitted as appropriate.

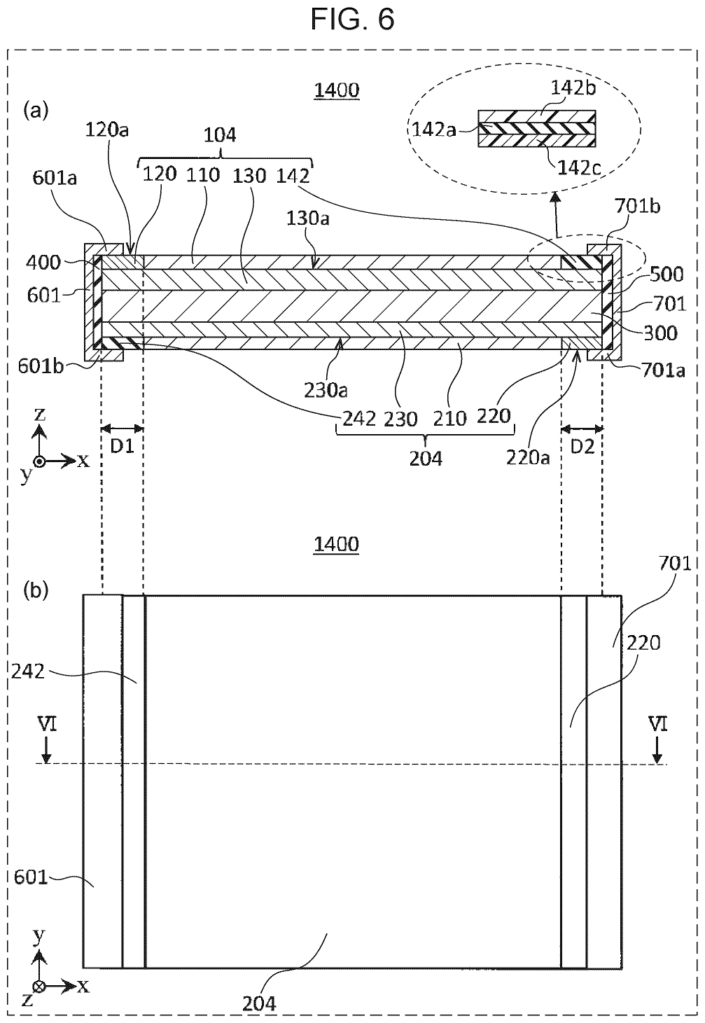

FIG. 6 illustrates a sectional view and a plan view illustrating the schematic configuration of a battery 1400 according to the fifth embodiment.

FIG. 6(a) is a sectional view of the battery 1400 according to the fifth embodiment. FIG. 6(b) is a plan view of the battery 1400 according to the fifth embodiment as seen from below in the z-axis direction. FIG. 6(a) illustrates a cross section taken along line VI-VI of FIG. 6(b).

As illustrated in FIG. 6, the battery 1400 has a configuration such that, in the configuration of the battery 1100 according to the second embodiment, the insulating layer is a multilayer film. That is, the battery 1400 includes a first electrode layer 104 including the first current collector layer 110, the first conductor layer 120, the first active material layer 130, and a first insulating layer 142 that is a multilayer film. Moreover, the battery 1400 includes a second electrode layer 204 including the second current collector layer 210, the second conductor layer 220, the second active material layer 230, and a second insulating layer 242 that is a multilayer film.

The first insulating layer 142 is a multilayer film having a three-layer structure. A rigid plate-shaped insulator is disposed as an internal layer 142a, and surface layers 142b and 142c are made of an insulating resin such as an epoxy resin.

As the plate-shaped insulator, for example, a high-density aluminum oxide plate (for example, having a relative density greater than or equal to 99.8%) can be used. The plate-shaped insulator may have any of the following surfaces: a rough surface (for example, with a surface roughness Rz greater than or equal to 1 μm and less than or equal to 10 μm); a surface having circular or rectangular protrusions and recesses (such that, for example, the height difference between the bottom of a recess and the top of a protrusion is greater than or equal to 10 μm and less than or equal to 100 μm); and a surface having a frame-shaped peripheral step (such that, for example, the height of the step is greater than or equal to 10 μm and less than or equal to 100 μm). Thus, the bondability between the internal layer 142a and the surface layers 142b and 142c in contact with the internal layer 142a is strengthened, and interlayer delamination due to a thermal cycle or the like is suppressed.

The first insulating layer 142 illustrated in FIG. 6 has a configuration such that the surface layer 142b and the surface layer 142c are respectively disposed on both main surfaces the internal layer 142a. However, the entire surface of the internal layer 142a may be covered by a surface layer made of an insulating resin. With such a configuration, a side-surface portion of the battery 1400 can be protected from an external impact by the internal layer 142a made of a rigid plate-shaped insulator, and, by bonding the first insulating layer 142 and the first active material layer 130 via a surface layer made of a soft resin, deformation of the first active material layer 130 can be absorbed by the surface layer and the bonded state can be maintained. Moreover, with such a configuration, the first insulating layer 142 can also maintain a state of being bonded to the first current collector layer 110. Accordingly, it is possible to realize the battery 1400 having high reliability, with which structural defects such as peeling of the first active material layer 130 from the first insulating layer 142 and peeling of the side surface of the first current collector layer 110 from the first insulating layer 142 are suppressed.

In the present embodiment, an example in which the first insulating layer 142 is a multilayer film having a three-layer structure has been described. However, the number of layers in the multilayer film is not limited to this, and may be four or more.

In the present embodiment, only the first insulating layer 142 has been described in detail. However, the second insulating layer 242 may have a configuration similar to that of the first insulating layer 142.

### Sixth Embodiment

Hereafter, a battery according to a sixth embodiment will be described. The matters described in the above embodiments may be omitted as appropriate.

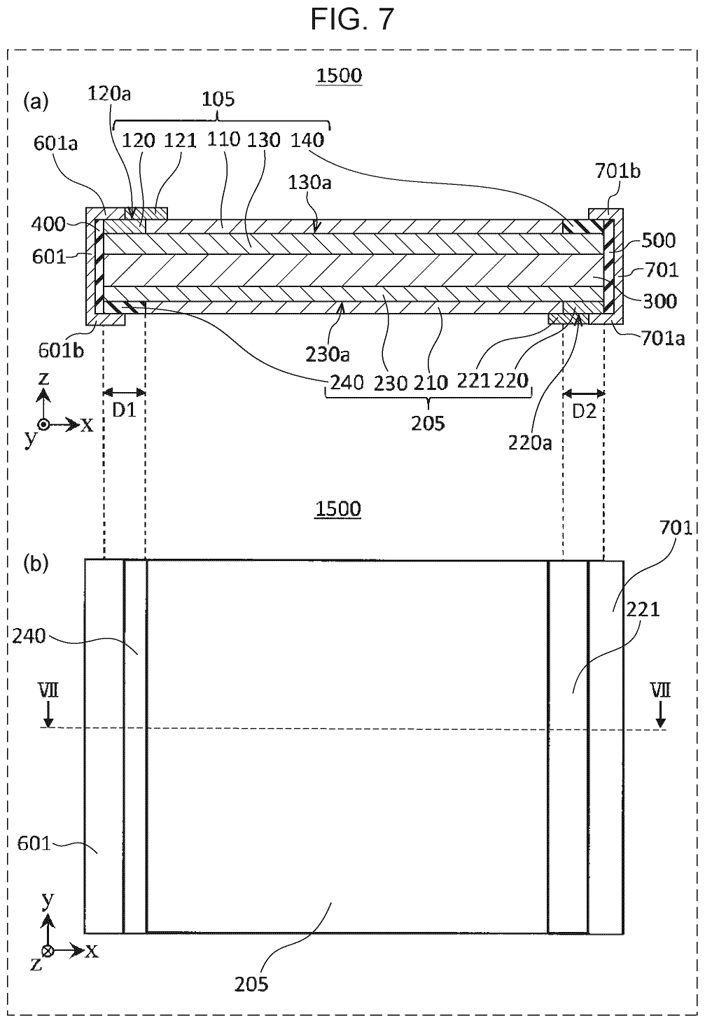

FIG. 7 illustrates a sectional view and a plan view illustrating the schematic configuration of a battery 1500 according to the sixth embodiment.

FIG. 7(a) is a sectional view of the battery 1500 according to the sixth embodiment. FIG. 7(b) is a plan view of the battery 1500 according to the sixth embodiment as seen from below in the z-axis direction. FIG. 7(a) illustrates a cross section taken along line VII-VII of FIG. 7(b).

As illustrated in FIG. 7, the battery 1500 further includes, in the configuration of the battery 1100 according to the second embodiment, a first covering conductor layer 121 that is disposed on both of the first main surface 120a of the first conductor layer 120 and the first main surface 110a of the first current collector layer 110, and a second covering conductor layer 221 that is disposed on both of the first main surface 220a of the second conductor layer 220 and the first main surface 210a of the second current collector layer 210. That is, the battery 1500 includes a first electrode layer 105 including the first current collector layer 110, the first conductor layer 120, the first active material layer 130, the first insulating layer 140, and the first covering conductor layer 121. Moreover, the battery 1500 includes a second electrode layer 205 including the second current collector layer 210, the second conductor layer 220, the second active material layer 230, the second insulating layer 240, and the second covering conductor layer 221.

In the present specification, the first covering conductor layer 121 and the second covering conductor layer 221 may be collectively and simply referred to as “covering conductor layer”.

The battery 1500 according to the sixth embodiment, which includes the covering conductor layer, can alleviate a problem in that the bonding portion between the current collector layer and the insulating layer is easily bent by an external stress. Moreover, since the electrical resistance between the current collector layer and the conductor layer can be reduced by the covering conductor layer, it is possible to obtain the battery 1500 having small resistance loss. Moreover, it is possible to suppress a problem in that a foreign substance (such as water, gas, a metal dust that may cause a short circuit, or the like) enters the bonding portion between the current collector layer and the conductor layer and deteriorates the battery characteristics.

The form of the covering conductor layer is not particularly limited. For example, by making the length of the overlapping portion of the covering conductor layer and the current collector layer greater than or equal to the thickness of the current collector layer from an end surface on the first main surface of the current collector layer, it is possible to further improve the bending resistance at the bonding portion between the current collector layer and the insulating layer. The thickness of the covering conductor layer can be set to any appropriate thickness. The number of the covering conductor layer(s) may be one, or may two or more. By increasing the area of the covering conductor layer, it is possible to reduce the electrical resistance between the current collector layer and the insulating layer. However, if the area of the covering conductor layer is excessively increased, volume energy density decreases, weight energy density decreases due to increase in thickness, and production cost increases. Therefore, it is desirable that the covering conductor layer have an appropriate form. A part of the covering conductor layer may be embedded in the first main surface of the current collector layer. The thickness of the embedded part of the covering conductor layer, which may depend on the thickness of the current collector layer, may be, for example, greater than or equal to 0.3 μm and less than or equal to 5 μm. Thus, the bondability between the covering conductor layer and the current collector layer is improved, and the bending resistance at the bonding portion between the current collector layer and the insulating layer of the battery 1500 is further improved.

With the above configuration, bending of the battery 1500 due to an external stress or the like is suppressed, the electrical resistance between the current collector layer and the conductor layer is reduced, and deterioration of the characteristics of the battery 1500 can be suppressed. Accordingly, it is possible to provide the battery 1500 having higher battery performance and higher reliability.

### Seventh Embodiment

Hereafter, a battery according to a seventh embodiment will be described. The matters described in the above embodiments may be omitted as appropriate.

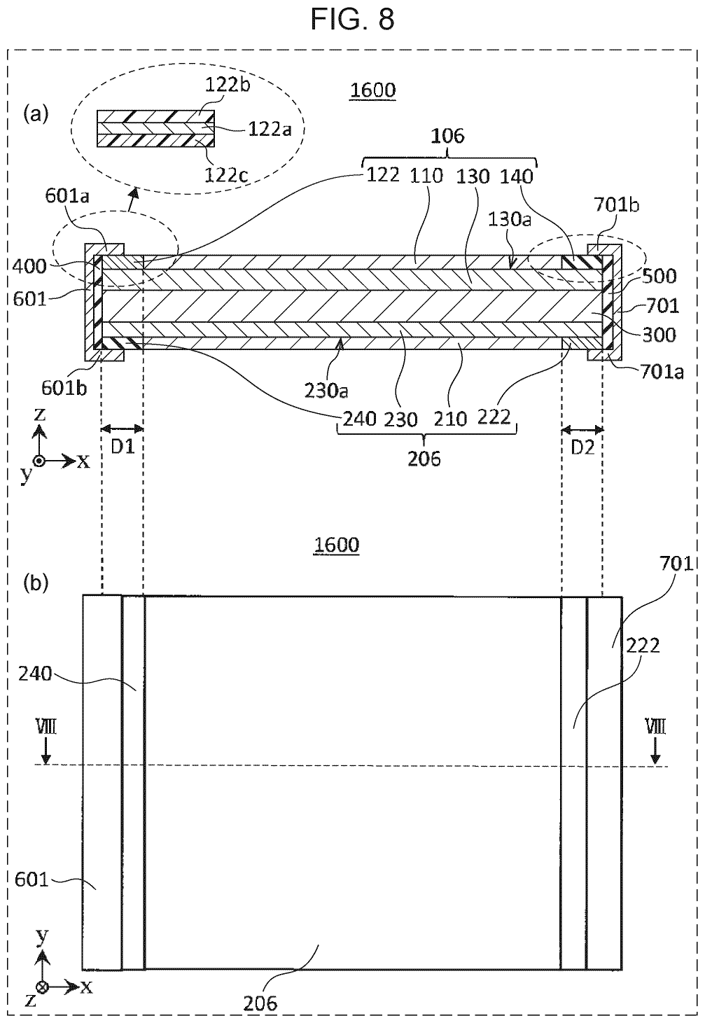

FIG. 8 illustrates a sectional view and a plan view illustrating the schematic configuration of a battery 1600 according to the seventh embodiment.

FIG. 8(a) is a sectional view of the battery 1600 according to the seventh embodiment. FIG. 8(b) is a plan view of the battery 1600 according to the seventh embodiment as seen from below in the z-axis direction. FIG. 8(a) illustrates a cross section taken along line VIII-VIII of FIG. 8(b).

As illustrated in FIG. 8, the battery 1600 has a configuration such that, in the configuration of the battery 1100 according to the second embodiment, the conductor layer is a multilayer film. That is, the battery 1600 includes a first electrode layer 106 including the first current collector layer 110, the first conductor layer 120, the first active material layer 130, and a first conductor layer 122 that is a multilayer film. Moreover, the battery 1600 includes a second electrode layer 206 including the second current collector layer 210, the second conductor layer 220, the second active material layer 230, and a second conductor layer 222 that is a multilayer film.

The first conductor layer 122 is a multilayer film having a three-layer structure. A rigid metal plate is disposed as an internal layer 122a, and surface layers 122b and 122c are each made of a conductive resin.

As the metal plate, for example, a copper plate can be used. The metal plate may have any of the following surfaces: a rough surface (for example, with a surface roughness Rz greater than or equal to 1 μm and less than or equal to 10 μm); a surface having circular or rectangular protrusions and recesses (such that, for example, the height difference between the bottom of a recess and the top of a protrusion is greater than or equal to 10 μm and less than or equal to 100 μm); or a surface having a frame-shaped peripheral step (such that, for example, the height of the step is greater than or equal to 10 μm and less than or equal to 100 μm). Thus, the bondability between the internal layer 122a and the surface layers 122b and 122c in contact the internal layer 122a is strengthened, and interlayer delamination due to a thermal cycle or the like is suppressed. In the metal plate, circular or rectangular holes (for example, through-holes) may be formed. Thus, it is possible to reduce weight while maintaining the mechanical strength of the conductor layer.

The conductive resin includes, for example, metal particles and a resin. As the metal particles, metal particles of Ag, Cu, Pt, Pd, or the like can be used. The metal particles may include mixture powder of two or more metals, or may include alloy powder. The size and shape of the metal particles are not particularly limited.

The first conductor layer 122 illustrated in FIG. 8 has a configuration such that the surface layer 122b and the surface layer 122c are respectively disposed on both main surfaces of the internal layer 122a. However, the entire surface of the internal layer 122a may be covered by a surface layer made of a conductive resin. With such a configuration, a side-surface portion of the battery 1600 can be protected from an external impact by the internal layer 122a made of a rigid metal plate, and, by bonding the first conductor layer 122 and the first active material layer 130 via a surface layer made of a soft resin, deformation of the first active material layer 130 can be absorbed by the surface layer and the bonded state can be maintained. Moreover, with such a configuration, the first conductor layer 122 can also maintain a state of being bonded with the first current collector layer 110. Moreover, since a metal plate having high sealability is used, entry of water, a gas, or the like that may deteriorate the characteristics, can be suppressed. Accordingly, it is possible to realize the battery 1600 having high reliability, with which structural defects such as peeling of the first active material layer 130 from the first conductor layer 122 and peeling of the side surface of the first current collector layer 110 from the first conductor layer 122 are suppressed.

In the present embodiment, an example in which the first conductor layer 122 is a multilayer film having a three-layer structure has been described. However, the number of layers in the multilayer film is not limited to this, and may be four or more.

In the present embodiment, only the first conductor layer 122 has been described in detail. However, the second conductor layer 222 may have a configuration similar to that of the first conductor layer 122.

### Eighth Embodiment

Hereafter, a battery according to an eighth embodiment will be described. The matters described in the above embodiments may be omitted as appropriate.

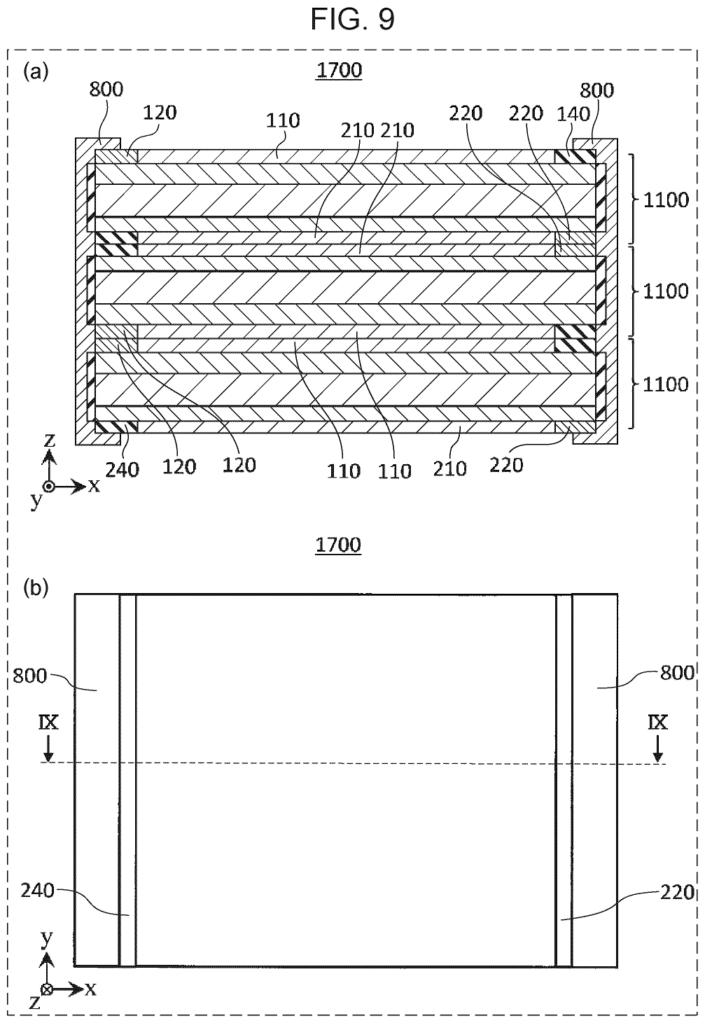

FIG. 9 illustrates a sectional view and a plan view illustrating the schematic configuration of a battery 1700 according to the eighth embodiment.

FIG. 9(a) is a sectional view of the battery 1700 according to the eighth embodiment. FIG. 9(b) is a plan view of the battery 1700 according to the eighth embodiment as seen from below in the z-axis direction. FIG. 9(a) illustrates a cross section taken along line IX-IX of FIG. 9(b).

As illustrated in FIG. 9, the battery 1700 has a structure such that a plurality of unit cells, each of which is the battery 1100 according to the second embodiment, are laminated. Note that the battery 1100 according to the second embodiment, which is used as a unit cell in the battery 1700, has a configuration such that a side surface of the first conductor layer 120 is not covered by the first-side-surface insulating layer 400 and a side surface of the second conductor layer 220 is not covered by the second-side-surface insulating layer 500. The battery 1700 is a laminated battery in which three batteries 1100 are laminated in such a way that the current collector layers having the same polarity face and contact each other so that the batteries 1100 are connected in parallel.

With the configuration described above, an assembled battery in which three unit cells are connected in parallel can be obtained, and thus it is possible to obtain the battery 1700 having high reliability and having three times the capacity of the battery 1100. Note that, by laminating the batteries 1100 in a direction such that the electrode layers having different polarities face each other so that the batteries 1100 are connected in series, it is also possible to obtain a battery having three times the voltage of the battery 1100, that is, a battery having higher energy. Both of increase of voltage and increase of capacity may be realized by using a combination of parallel connection and serial connection.

The battery 1700 illustrated in FIG. 9 has a configuration such that only the batteries 1100 each according to the second embodiment are laminated. However, it is also possible to use any of the batteries according to the third to seventh embodiments as a unit cell.

In the battery 1700 according to the eighth embodiment, a terminal electrode 800 is formed by the lead-out conductor members of the batteries 1100. A metal plating film may be provided on a surface of the terminal electrode 800. The metal plating film may be, for example, solder plating such Ni—Sn plating. Characteristics may be extracted by connecting bonding wires or the like to the first current collector layer of a battery 1100 that is positioned at one main surface of the battery 1700 and to the second current collector layer of a battery 1100 that is positioned at the other main surface of the battery 1700. Connection can be made to a mount substrate that includes a connection portion with the terminal electrode 800 by using a conductive material (such as a conductive adhesive or a solder component).

### Method of Manufacturing Battery

Next, an example of a method of manufacturing a battery according to the present embodiment will be described. Hereafter, a method of manufacturing the battery 1100 according to the second embodiment described above will be described.

Hereafter, an example in which the first electrode layer 100 is a positive electrode and the second electrode layer 200 is a negative electrode will be described.

First, a paste for forming the positive-electrode active material layer by printing and a paste for forming the negative-electrode active material layer by printing are made. As a solid electrolyte used for a mixture of the positive-electrode active material layer and the negative-electrode active material layer, for example, grass power of Li₂S—P₂S₅-based sulfide having an average particle diameter of about 2 μm and including a triclinic-system crystal as a main component is prepared. The glass powder has, for example, ion conductivity of 3×10⁻³ S/cm to 4×10⁻³ S/cm.

As a positive-electrode active material, for example, powder of Li·Ni·Co·Al composite oxide (LiNi_{0.8}Co_{0.15}Al_{0.05}O₂) having an average particle diameter of about 3 μm and having a layered structure is used.

By dispersing a mixture including the positive-electrode active material and the glass powder in an organic solvent or the like, a paste for the positive-electrode active material layer is made.

By dispersing a mixture including glass powder in an organic solvent or the like, a slurry for a solid electrolyte layer used to form a solid electrolyte layer is made.

As the negative-electrode active material, for example, natural graphite powder having an average particle diameter of about 4 μm is used. By dispersing the negative-electrode active material and the glass powder in an organic solvent or the like, a paste for the negative-electrode active material layer is made.

Next, as materials to be used as the positive electrode current collector and the negative electrode current collector, for example, an Al foil and a Cu foil having a thickness of about 20 μm are respectively prepared. By using a screen printing method, the paste for the positive-electrode active material layer and the paste for the negative-electrode active material layer are each printed on one surface of a corresponding one of the foils to have a predetermined shape with a thickness of about 50 μm to 100 μm. The paste for the positive-electrode active material layer and the paste for the negative-electrode active material layer are dried at a temperature of 80° C. to 130° C. to have a thickness of 30 μm to 60 μm. Thus, the positive-electrode current collector layer on one surface of which the positive-electrode active material layer is formed and that is made of the Al foil and the negative-electrode current collector layer on one surface of which the negative-electrode active material layer is formed and that is made of the Cu-foil are obtained.

On the positive-electrode active material layer and on the negative-electrode active material layer, by using a metal mask, the paste for the solid electrolyte layer is printed, for example, with a thickness of about 100 μm. Subsequently, the printed paste for the solid electrolyte layer is dried at 80° C. to 130° C., and the solid electrolyte layer is formed.

Next, the solid electrolyte layer formed on the positive-electrode active material layer and the solid electrolyte layer formed on the negative-electrode active material layer are laminated so as to contact and face each other. Thus, a laminated body in which the positive-electrode current collector layer, the positive-electrode active material layer, the solid electrolyte layer, the negative-electrode active material layer, and the negative-electrode current collector layer are laminated is obtained.

Next, the laminated body is pressed in the laminating direction. Between a compression-die plate and an upper surface of the laminated body, an elastic material sheet (thickness: 50 μm to 100 μm) having an elastic modulus of about 5×10⁶ Pa is inserted. A surface of the elastic material sheet in contact with the laminated body may have been embossed to have a surface roughness Rz of about 1 μm to 10 μm. Subsequently, pressure is applied for about 90 seconds by using the compression die with a pressure 300 MPa to 350 MPa while heating the compression die at 50° C. to 80° C.

Next, from the positive-electrode current collector layer and the negative-electrode current collector layer, a region to become a portion where the insulating layer is to be provided and a region to become a portion where the conductor layer is to provided are removed. For example, by using a sharp cutter made of a metal, a slit is formed in a surface of the current collector layer to have a depth less than or equal to the thickness of the current collector layer, thereby peeling a portion of the current collector layer in a predetermined region from the active material layer. Instead of the cutter, laser or the like may be used to form the slit in the current collector layer. At this time, in order to increase the peelability of the current collector layer, before applying a paste for the active material layer, a silicone-based or fluorocarbon-resin-based general release agent may be applied to a portion of the current collector layer to be peeled off. Thus, the peelability of the current collector layer from the active material layer is improved, and the current collector layer can be peeled off without generating a breakage or a crack in the active material layer. The silicone-based or fluorocarbon-resin-based release agent that remains on the active material layer has a very small thickness of several nanometers to several hundreds of nanometers. Accordingly, the remaining release agent does not affect conductivity. The remaining release agent functions as a protective film for the surface of the active material layer, and provides an advantageous effect of suppressing an influence from materials, such as water and a sulfide gas, that deteriorate the characteristics of the active material. It is possible to examine the release agent by performing elemental analysis, such as EPMA, of a cross section treated by ion polishing or the like.

Next, on one main surface of the laminated body, the insulating layer and the conductor layer are formed in the region from which the current collector layer has been peeled. For example, an insulating paste including a thermosetting insulating epoxy resin that does not easily contract in volume is applied to a region for forming the insulating layer and a conductor paste including a conductive resin is applied to a region for forming the conductor layer each by screen printing so that each paste has the same thickness as the current collector layer, and the pastes are cured at 120° C. to 150° C. for 30 minutes to 120 minutes. Thus, the insulating layer and the conductor layer are formed. Next, on the other main surface of the laminated body, the insulating layer and the conductor layer are formed in a similar manner. When the insulating layer and the conductor layer are to be formed as multilayer films, for example, application and curing of the materials are repeatedly performed.

Next, the side-surface insulating layer is formed on the side surface of the obtained laminated body. For example, by using an edge coating method performed for a chip component such as MLCC, for example, in the same way as in the case of the insulating layer, an insulating paste including a thermosetting insulating epoxy resin is applied to the side surface of the laminated body with a thickness of 150 μm to 200 μm and cured at 110° C. to 140° C. for 20 minutes to 100 minutes. For example, the insulating paste is applied onto a smooth metal plate so as to form a flat film, and the side surface of the laminated body is pressed against a smooth surface of the insulating paste applied onto the metal plate and pulled upward. The thickness of the side surface can be controlled by adjusting the thickness, the viscosity, and the like of the insulating paste applied onto the metal plate. The thickness of the side-surface insulating layer may be any thickness as long as the layer can have insulating properties.

Next, the lead-out conductor member is formed on a surface of the side-surface insulating layer. For example, by using a conductor paste of a thermosetting conductive resin or the like including Ag particles, the lead-out conductor member is applied with a thickness of 100 μm to 150 μm and cured at 100° C. to 130° C. for 20 minutes to 80 minutes, as with the side-surface insulating layer. In this way, the battery 1100 is obtained.

By using the battery 1100 obtained as described above as a unit cell and by laminating multiple unit cells to be connected to each other in series or in parallel, it is possible to realize a high-voltage high-capacity laminated battery. For example, a thermosetting conductor paste including Ag particles is screen printed onto the main surface of the first current collector layer of the battery 1100 with a thickness of about 1 μm to 5 μm. Another battery 1100 is placed on the battery 1100 so that the first current collector layers thereof face each other to form a parallel connection, and the batteries 1100 are press bonded with a pressure of about 10 kg/cm². To increase the number of unit cells to be connected in parallel, the same process is repeated to laminate a desirable number of unit cells. Subsequently, for example, while applying a pressure of about 1 kg/cm² in the laminating direction and immobilizing the unit cells, heat-curing treatment is performed at about 100° C. to 130° C. for 40 minutes to 100 minutes, and then the unit cells are gradually cooled to the room temperature. In this way, a laminated battery (for example, the battery 1700 according to the eighth embodiment) can be obtained. As the conductive resin material for forming the conductor layer, various materials having different curing temperatures or including different conductive particles can be used. For example, when a thin conductor layer is to be formed, conductor particles such as Ag particles may be changed to smaller particles, or scale-shaped particles may be used. In order to form an alloy together with the current collector layer by heat treatment for curing, the material of the conductor layer may include a low-melting point metal.

A method of manufacturing the battery is not limited to the example described above.

In the manufacturing method described above, an example in which a paste for the positive-electrode active material layer, a paste for the negative-electrode active material layer, a paste for the solid electrolyte layer, a paste for the conductor paste, and an insulating paste are applied by printing is described. However, this is not a limitation. As the application method, for example, a doctor blade method, a calendar method, a spin coating method, a dip coating method, an inkjet method, an offset method, a die coating method, a spraying method, or the like may be used.

In the manufacturing method described above, a thermosetting conductor paste including metal particles of silver is described as an example of the conductor paste, but the conductor paste is not limited to this. As the conductor paste, a thermosetting conductor paste including high-melting-point (for example, higher than or equal to 400° C.) highly-conductive metal particles, low-melting-point (desirably, lower than the curing temperature of the conductor paste, for example, lower than or equal to 300° C.), and a resin may be used. Examples of the material of the high-melting-point highly-conductive metal particles include silver, copper, nickel, zinc, aluminum, palladium, gold, platinum, and an alloy of any of these. Examples of the material of metal particles whose melting point is lower than or equal to 300° C. include tin, a tin-zinc alloy, a tin-silver alloy, a tin-copper alloy, a tin-aluminum alloy, a tin-lead alloy, indium, an indium-silver alloy, an indium-zinc alloy, an indium-tin alloy, bismuth, a bismuth-silver alloy, a bismuth-nickel alloy, a bismuth-tin alloy, a bismuth-zinc alloy, and a bismuth-lead alloy. When a conductor paste including such low-melting-point metal particles is used, even at a curing temperature that is lower than the melting point of the high-melting-point conductive metal particles, solid-phase and liquid-phase reactions proceed in a contact portion between the metal particles in the conductor paste and a metal included in the current collector. Thus, at the interface between the conductor paste and the surface of the current collector, a diffusion region in which an alloy is formed by the solid-phase and liquid-phase reactions is formed around the contact portion. An example of the formed alloy is a silver-copper-based alloy, which is a highly conductive alloy, when silver or a silver alloy is used for the conductive metal particles and copper is used for the current collector. Moreover, depending on the combination of the conductive metal particles and the current collector, a silver-nickel alloy, a silver-palladium alloy, or the like may be formed. With this configuration, it is possible to obtain advantageous effects of stronger bonding, such as suppression of delamination at a bonded portion due to a thermal cycle or an impact.

The shape of the high-melting-point highly-conductive metal particles and the low-melting-point metal particles may be any shape, such as a spherical shape, a scale-like shape, a needle-like shape, or the like. The particle size of the high-melting-point highly-conductive metal particles and the low-melting-point metal particles is not particularly limited. For example, since an alloy reaction and dispersion proceed at a lower temperature when the particle size is smaller, the size and shape of the particles are appropriately selected in consideration of the process design and an effect of thermal hysteresis on battery characteristics.

The resin used for the thermosetting conductor paste and the insulating paste may be any resin that can function as a binder, and an appropriate resin is selected in accordance with printability, applicability, and a manufacturing process to be used. The resin used for the thermosetting conductor paste includes, for example, a thermosetting resin. Examples of the thermosetting resin include the following: (i) an amino resin such as urea resin, melamine resin, or guanamine resin; (ii) an epoxy resin such as bisphenol-A epoxy resin, bisphenol-B epoxy resin, phenol novolac epoxy resin, or cycloaliphatic epoxy resin; (iii) an oxetane resin; (iv) a phenol resin such as resol phenol resin or novolac phenol resin; and (v) a silicone-modified organic resin such as silicone epoxy resin or silicone polyester resin. As the resin, only one of these materials may be used, or two or more of these materials may be used in combination.

### Other Embodiments

### Appendix

Based on the above description of the embodiments, the following technologies are disclosed.

### Technology 1

A battery comprising:
a first electrode layer;
a second electrode layer; and
a solid electrolyte layer that is disposed between the first electrode layer and the second electrode layer,
wherein the first electrode layer includes a first active material layer, and a first current collector layer and a first conductor layer that are disposed on a first main surface of the first active material layer,
wherein the first conductor layer is made of a material different from a material of the first current collector layer, is positioned adjacent to a first side surface of the battery, and is electrically connected to the first current collector layer, and
wherein the battery further comprises a first lead-out conductor member that is electrically connected to the first conductor layer.

With the configuration described above, the first lead-out conductor member and first current collector layer are electrically connected via the first conductor layer. As with the first current collector layer, the first conductor layer is disposed on the first main surface of the first active material layer. That is, the first conductor layer is positioned on the same plane as the first current collector layer. In this way, since the first lead-out conductor member and the first current collector layer are electrically connected via the first conductor layer that is positioned on the same plane as the first current collector layer, it is possible to suppress occurrence of a problem in that the bonding between a side surface of the first current collector layer and the first lead-out conductor member is easily disrupted by expansion and contraction of the battery. Accordingly, the battery according to technology 1 can realize high reliability. Moreover, with this configuration, for example, it is possible to select the material of the first conductor layer from materials that are suitable for bonding with the first lead-out conductor member. For example, with the battery according to technology 1, it is also possible to select, as the material of the first conductor layer, a material that is softer than the material of the first current collector layer, and it is also possible to realize a configuration that can further improve reliability.

### Technology 2

The battery according to technology 1,
wherein the second electrode layer includes a second active material layer, and a second current collector layer and a second conductor layer that are disposed on a first main surface of the second active material layer,
wherein the second conductor layer is made of a material different from a material of the second current collector layer, is positioned adjacent to a second side surface of the battery opposite to the first side surface of the battery, and is electrically connected to the second current collector layer, and
wherein the battery further comprises a second lead-out conductor member that is electrically connected to the second conductor layer.

With the configuration described above, the second lead-out conductor member and second current collector layer are electrically connected via the second conductor layer. As with the second current collector layer, the second conductor layer is disposed on the first main surface of the second active material layer. That is, the second conductor layer is positioned on the same plane as the second current collector layer. In this way, since the second lead-out conductor member and the second current collector layer are electrically connected via the second conductor layer that is positioned on the same plane as the second current collector layer, it is possible to suppress occurrence of a problem in that the bonding between a side surface of the second current collector layer and the second lead-out conductor member is easily disrupted by expansion and contraction of the battery. Accordingly, the battery according to technology 2 can realize high reliability. Moreover, with this configuration, for example, it is possible to select the material of the second conductor layer from materials that are suitable for bonding the second conductor layer and the second lead-out conductor member. For example, with the battery according to technology 2, it is also possible to select, as the material of the second conductor layer, a material that is softer than the material of the second current collector layer, and it is also possible to realize a configuration that can further improve reliability.

### Technology 3

The battery according to technology 1 or 2, further comprising:
a first-side-surface insulating layer that covers a first side surface of a laminated body composed of the first active material layer, the solid electrolyte layer, and the second active material layer,
wherein at least a part of the first lead-out conductor member is disposed on a surface of the first-side-surface insulating layer.

With the configuration described above, when a laminated battery is to be formed by laminating a plurality of batteries, it is possible to form an assembled battery having an integrated structure without using lead wires that may break easily. It is possible to select whether to laminate the plurality of batteries to be connected in parallel or in series. Accordingly, with the battery according to technology 3, it is possible to realize a small high-capacity battery while realizing high reliability. In this way, with the battery according to technology 3, by causing the first conductor layer to absorb deformation due to charging and discharging of the battery or the like, it is possible to realize electrical connection between the first current collector layer and the first lead-out conductor member with high reliability and low resistance, and it is possible to realize a small high-capacity battery having high reliability.

### Technology 4

The battery according to technology 2 or 3, further comprising:
a second-side-surface insulating layer that covers a second side surface of a laminated body composed of the first active material layer, the solid electrolyte layer, and the second active material layer, the second side surface being opposite to a first side surface of the laminated body,
wherein at least a part of the second lead-out conductor member is disposed on a surface of the second-side-surface insulating layer.

With the configuration described above, when a laminated battery is to be formed by laminating a plurality of batteries, it is possible to form an assembled battery having an integrated structure without using lead wires that may break easily. It is possible to select whether to laminate the plurality of batteries to be connected in parallel or in series. Accordingly, with the battery according to technology 4, it is possible to realize a small high-capacity battery while realizing high reliability. In this way, with the battery according to technology 4, by causing the second conductor layer to absorb deformation due to charging and discharging of the battery or the like, it is possible to realize electrical connection between the second current collector layer and the second lead-out conductor member with high reliability and low resistance, and it is possible to realize a small high-capacity battery having high reliability.

### Technology 5

The battery according to any one of technologies 1 to 4,
wherein the first electrode layer further includes a first insulating layer disposed at a position that is on the first main surface of the first active material layer and that is adjacent to a second side surface of the battery opposite to the first side surface of the battery.

In this way, since the first insulating layer, which is disposed at a position that is on the first main surface of the first active material layer and that is adjacent to the second side surface of the battery, is provided, the first electrode layer can be strongly bonded to the second-side-surface insulating layer. Accordingly, it is possible to suppress a problem in that the second-side-surface insulating layer is easily peeled from the second side surface of the laminated body composed of the first active material layer, the solid electrolyte layer, and the second active material layer due to deformation caused by charging and discharging of the battery or the like. Accordingly, it is possible to realize a battery with which deterioration of characteristics due to a short circuit or a structural defect is suppressed and that has higher reliability.

### Technology 6

The battery according to any one of technologies 2 to 5,
wherein the second electrode layer further includes a second insulating layer disposed at a position that is on the first main surface of the second active material layer and that is adjacent to the first side surface of the battery.

In this way, since the second insulating layer, which is disposed at a position that is on the first main surface of the second active material layer and that is adjacent to the first side surface of the battery, is provided, the second electrode layer can be strongly bonded to the first-side-surface insulating layer. Accordingly, it is possible to suppress a problem in that the second-side-surface insulating layer is easily peeled from the first side surface of the laminated body composed of the first active material layer, the solid electrolyte layer, and the second active material layer due to deformation caused by charging and discharging of the battery or the like. Accordingly, it is possible to realize a battery with which deterioration of characteristics due to a short circuit or a structural defect is suppressed and that has higher reliability.

### Technology 7

The battery according to any one of technologies 1 to 6,
wherein the first lead-out conductor member includes a wraparound portion that is continuous from the first side surface of the battery onto a first main surface of the first conductor layer that does not face the first active material layer, and the first lead-out conductor member is in contact with the first conductor layer at the first main surface of the first conductor layer.

With this configuration, the first lead-out conductor member and the first conductor layer can be electrically connected to each other with low resistance. To be specific, for example, it is possible to reduce resistance because the area of contact between the first lead-out conductor member and the first conductor layer is increased. Moreover, due to connection of the first conductor layer with the first lead-out conductor member including the wraparound portion (that is, a ridge portion of the first lead-out conductor member in a cross section of the battery), connection resistance can be reduced without increasing the size. Accordingly, it is possible to obtain a small high-capacity battery having small resistance loss.

### Technology 8

The battery according to any one of technologies 2 to 7,
wherein the second lead-out conductor member includes a wraparound portion that is continuous from the second side surface of the battery onto a first main surface of the second conductor layer that does not face the second active material layer, and the second lead-out conductor member is in contact with the second conductor layer at the first main surface of the second conductor layer.

With this configuration, the second lead-out conductor member and the second conductor layer can be electrically connected to each other with low resistance. To be specific, for example, it is possible to reduce resistance because the area of contact between the second lead-out conductor member and the second conductor layer is increased. Moreover, due to connection of the second conductor layer with the second lead-out conductor member including the wraparound portion (that is, a ridge portion of the second lead-out conductor member in a cross section of the battery), connection resistance can be reduced without increasing the size. Accordingly, it is possible to obtain a small high-capacity battery having small resistance loss.

### Technology 9

The battery according to technology 7,
wherein a thickness of the wraparound portion of the first lead-out conductor member is smaller than a thickness of the first lead-out conductor member on the first side surface of the battery and a thickness of the first lead-out conductor member on the first main surface of the first conductor layer.

With this configuration, it is possible to suppress a crack in the first lead-out conductor member that is easily generated, for example, along a ridge in the wraparound portion, which is bent, due to expansion/contraction stress of the battery caused by charging and discharging operations. Thus, since open-circuit failure and increase in resistance of the connection portion can be suppressed, it is possible to obtain a battery having high reliability.

### Technology 10

The battery according to technology 8,
wherein a thickness of the wraparound portion of the second lead-out conductor member is smaller than a thickness of the second lead-out conductor member on the second side surface of the battery and a thickness of the second lead-out conductor member on the first main surface of the second conductor layer.

With this configuration, it is possible to suppress a crack in the second lead-out conductor member that is easily generated, for example, along a ridge in the wraparound portion, which is bent, due to expansion/contraction stress of the battery caused by charging and discharging operations. Thus, since open-circuit failure and increase in resistance of the connection portion can be suppressed, it is possible to obtain a battery having high reliability.

### Technology 11

The battery according to technology 5 or 6,
wherein at least one selected from the group consisting of the first insulating layer and the second insulating layer is a plate-shaped member including an inorganic material.

With this configuration, a side-surface portion of the battery, which may easily break due to an external impact, can be reinforced by a plate-shaped member including an inorganic material, which is more rigid than the active material layer and the solid electrolyte layer, which are constituent members of the battery element.

### Technology 12

The battery according to technology 5 or 6,
wherein at least one selected from the group consisting of the first insulating layer and the second insulating layer includes a resin.

With this configuration, since the elasticity of the resin, that is, the softness of the resin can absorb expansion and contraction of the active material caused by charging and discharging, the adhesion of the bonding surface between the insulating layer and the active material layer and the adhesion between the insulating layer and the side-surface insulating layer and the lead-out conductor member can be maintained. Accordingly, it is possible to realize a battery having excellent charge-discharge cycle characteristics, because the lead-out conductor member, the side-surface insulating layer, the insulating layer, and the active material layer are strongly connected.

### Technology 13

The battery according to claim 12,
wherein at least one selected from the group consisting of the first insulating layer and the second insulating layer includes a thermosetting resin.

With this configuration, since the insulating layer can be formed in a general laminating process for manufacturing the battery, it is possible to realize a battery having high productivity. For example, the insulating layer can be formed by curing an applied film by heat treatment after printing or applying a paste resin for forming the insulating layer including a thermosetting resin. By applying the paste resin for forming the insulating layer onto the active material layer including an organic binder and curing the paste resin when the active material layer is soft (for example, has a high temperature and is soft) and cooling the paste resin to the room temperature, thermal expansion coefficient difference at the interface between the insulating layer and the active material layer can be absorbed. Thus, it is possible to bond the insulating layer and the active material layer while suppressing generation of a structural defect such as a crack or interfacial delamination.

### Technology 14

The battery according to technology 5 or 6,
wherein at least one selected from the group consisting of the first insulating layer and the second insulating layer is a multilayer film.

With this configuration, regarding a surface layer of the conductor layer in contact with the active material layer and regarding an internal layer of the conductor layer, it is possible to change each of: various properties such as hardness, density, thermal expansion coefficient, and thermal conductivity; type of material; curing conditions; and the like. For example, regarding the surface layer of the conductor layer, by appropriately selecting the properties, material, and the like, it is possible to improve the adhesion of the bonding surface between the conductor layer and the active material layer. Moreover, it is possible to use a layer having high density and high sealing properties (such as watertightness and gas-tightness) as an internal layer of the side-surface insulating layer. To be specific, for example, an alumina plate, an aluminum laminate film, or the like having high density may be inserted into an internal layer portion. Thus, for example, with the insulating layer, while suppressing peeling from the active material layer, entry of water or a gas component that deteriorates the battery characteristics into the battery can be suppressed, and it is possible to realize a battery having high reliability.

### Technology 15

The battery according to technology 14,
wherein a surface layer forming a main surface of the multilayer film is softer than an internal layer of the multilayer film.

With this configuration, the soft surface layer of the insulating layer can absorb expansion and contraction of the active material layer caused by charging and discharging. Thus, the adhesion of the bonding surface between the insulating layer and the active material layer under a charge-discharge cycle is further improved, and therefore it is possible to realize a battery having high reliability.

### Technology 16

The battery according to technology 14,
wherein the multilayer film includes a thermosetting resin, and wherein a curing temperature of a material of a surface layer forming a main surface of the multilayer film is lower than a curing temperature of a material of an internal layer of the multilayer film.

An internal layer of the conductor layer has a problem in that excessive thermal hysteresis is accumulated in a repetitive curing process of a multilayer film such as curing of a surface layer and the like, and generation of a crack, strength reduction, and the like due to deterioration of a resin component occur easily. However, as in the above configuration, when the material of a surface layer of the conductor layer has a curing temperature lower than that of the material of an internal layer, it is possible to form an insulating layer of a multilayer film while suppressing deterioration of a resin in an inner layer portion. Accordingly, an insulating layer having high bonding reliability with the active material layer can be formed. Thus, it is possible to obtain a battery having higher reliability.

### Technology 17

The battery according to technology 3 or 4,
wherein at least one selected from the group consisting of the first-side-surface insulating layer and the second-side-surface insulating layer includes a resin.

With this configuration, the elasticity, that is, the softness of the side-surface insulating layer can absorb deformation of a side-surface portion of the battery, which expands and contracts due to charging and discharging operations. Accordingly, it is possible to suppress peeling of the side-surface insulating layer from the laminated body composed of the first active material layer, the solid electrolyte layer, and the second active material layer, that is, peeling of the side-surface insulating layer from the active material layer and the solid electrolyte layer, which are constituent members of the battery element. For example, a layer that is softer than the constituent members of the battery element is suitable for the side-surface insulating layer. Moreover, due to the sealing properties of a resin material, the side-surface insulating layer can suppress entry of water and a gas component that deteriorates the battery characteristics into the battery. Moreover, since the side-surface insulating layer, in which the resin material is used, can absorb a stress difference at the bonding interface between the side-surface insulating layer and the lead-out conductor member disposed on a surface of the side-surface insulating layer, it is possible to suppress delamination at the interface between the side-surface insulating layer and the lead-out conductor member.

### Technology 18

The battery according to technology 17,
wherein at least one selected from the group consisting of the first-side-surface insulating layer and the second-side-surface insulating layer includes a thermosetting resin.

With this configuration, it is possible to form the side-surface insulating layer by using a method of applying a terminal electrode, which is a so-called edge coating method, or the like that is generally used to manufacture a chip component such as an MLCC. Accordingly, it is possible to realize a battery having high productivity and high reliability. In a case where a laminated body composed of the first active material layer, the solid electrolyte layer, and the second active material layer includes an organic binder, by applying a paste resin for forming the side-surface insulating layer to a side surface of the laminated body including the organic binder and curing the paste resin when the side surface of the laminated body is soft (for example, has a high temperature and is soft) and cooling the paste resin to the room temperature, thermal expansion coefficient difference at an interface between the side-surface insulating layer and the side surface of the laminated body can be absorbed. Thus, it is possible to bond the side-surface insulating layer and the side surface of the laminated body while suppressing generation of a structural defect such as a crack or interfacial delamination.

### Technology 19

The battery according to technology 3 or 4,
wherein at least one selected from the group consisting of the first-side-surface insulating layer and the second-side-surface insulating layer is a multilayer film.

With this configuration, regarding the bonding surface between the side-surface insulating layer and a side surface of a laminated body composed of the first active material layer, the solid electrolyte layer, and the second active material layer and regarding the bonding surface between the side-surface insulating layer and the lead-out conductor member, it is possible to change each of: various properties such as hardness, density, thermal expansion coefficient, and thermal conductivity; type of material; curing conditions; and the like. Thus, it is possible to improve the adhesion between the side-surface insulating layer, the side surface of the laminated body, and the lead-out conductor member. Therefore, the bonding reliability of the side-surface insulating layer against a charge-discharge cycle and an external stress is increased. Moreover, it is possible to use a layer having high density and high sealing properties (such as watertightness and gas-tightness) as an internal layer of the side-surface insulating layer. To be specific, for example, an alumina plate, an aluminum laminate film, or the like having high density may be inserted into an internal layer portion. Thus, entry of water or a gas component that deteriorates the battery characteristics into the battery through an interlayer gap in the battery side surface can be suppressed, and it is possible to realize a battery having high reliability.

### Technology 20

The battery according to technology 19,
wherein a surface layer forming a main surface of the multilayer film is softer than an internal layer of the multilayer film.

With this configuration, the soft surface layer of the side-surface insulating layer can absorb a stress that is generated at the bonding surface with the lead-out conductor member due to expansion and contraction of the battery caused by charging and discharging. Thus, the adhesion between the side-surface insulating layer and the lead-out conductor member under a charge-discharge cycle is further improved and interfacial delamination is suppressed, and therefore it is possible to realize a battery having high reliability.

### Technology 21

The battery according to technology 19,
wherein the first electrode layer further includes a first insulating layer disposed at a position that is on the first main surface of the first active material layer and that is adjacent to a second side surface of the battery opposite to the first side surface of the battery, wherein the second electrode layer further includes a second insulating layer disposed at a position that is on the first main surface of the second active material layer and that is adjacent to the first side surface of the battery, wherein the multilayer film includes a thermosetting resin, wherein a curing temperature of the thermosetting resin included in the multilayer film is lower than a curing temperature of a thermosetting resin included in the first insulating layer and the second insulating layer, and wherein a curing temperature of a material of a surface layer forming a main surface of the multilayer film is lower than a curing temperature of a material of an internal layer of the multilayer film.

The first insulating layer and the first side-surface insulating layer have a problem in that excessive thermal hysteresis is accumulated in a repetitive curing process, and generation of a crack, strength reduction, and the like due to deterioration of a resin component occur easily. However, as in the above configuration, when the curing temperature of a thermosetting resin included in the multilayer film of the first side-surface insulating layer is lower than the curing temperature of a thermosetting resin included in the first insulating layer and the curing temperature of the material of the surface layer forming a main surface of the multilayer film of the first side-surface insulating layer is lower than the curing temperature of the material of an internal layer, it is possible to form the first insulating layer and the first side-surface insulating layer while suppressing accumulation of excessive thermal hysteresis and suppressing resin deterioration. Thus, it is possible to suppress generation of a crack and strength reduction in the first insulating layer and the first side-surface insulating layer. Accordingly, it is possible to obtain a battery having higher reliability. Moreover, with this configuration, it is possible to selectively make the surface layer of the first side-surface insulating layer softer than the internal layer.

The second insulating layer and the side-surface insulating layer also have a problem in that excessive thermal hysteresis is accumulated in a repetitive curing process, and generation of a crack, strength reduction, and the like due to deterioration of a resin component occur easily. However, as in the above configuration, when the curing temperature of a thermosetting resin included in the multilayer film of the second side-surface insulating layer is lower than the curing temperature of a thermosetting resin included in the second insulating layer and the curing temperature of the material of the surface layer forming a main surface of the multilayer film of the second side-surface insulating layer is lower than the curing temperature of the material of an internal layer, it is possible to form the second insulating layer and the second side-surface insulating layer while suppressing accumulation of excessive thermal hysteresis and suppressing resin deterioration. Thus, it is possible to suppress generation of a crack and strength reduction in the second insulating layer and the second side-surface insulating layer. Accordingly, it is possible to obtain a battery having higher reliability. Moreover, with this configuration, it is possible to selectively make the surface layer of the second side-surface insulating layer softer than the internal layer.

### Technology 22

The battery according to any one of technologies 1 to 21,
wherein at least one selected from the group consisting of the first conductor layer and the second conductor layer is a plate-shaped member including a metal material.

With this configuration, a side-surface portion of the battery, which may easily break due to an external impact, can be reinforced by a plate-shaped member including a metal material, which is more rigid than the active material layer and the solid electrolyte layer, which are constituent members of the battery element.

### Technology 23

The battery according to any one of technologies 1 to 22,
wherein at least one selected from the group consisting of the first conductor layer and the second conductor layer includes a resin.

With this configuration, since the elasticity of the resin, that is, the softness of the resin can absorb expansion and contraction of the active material caused by charging and discharging, the adhesion of the bonding surface between the conductor layer and the active material layer and the adhesion of the bonding surface between the conductor layer and the lead-out conductor member can be maintained. Accordingly, it is possible to realize a battery having excellent charge-discharge cycle characteristics, because the conductor layer, the lead-out conductor member, and the active material layer are strongly connected.

### Technology 24

The battery according to technology 23,
wherein at least one selected from the group consisting of the first conductor layer and the second conductor layer includes a thermosetting resin.

With this configuration, since the conductor layer can be formed in a general laminating process for manufacturing the battery, it is possible to realize a battery having high productivity. For example, the conductor layer can be formed by curing an applied film by heat treatment after printing or applying a paste resin for forming the conductor layer including a thermosetting resin. By applying the paste resin for forming the conductor layer onto the active material layer including an organic binder and curing the paste resin when the active material layer is soft (for example, has a high temperature and is soft) and cooling the paste resin to the room temperature, thermal expansion coefficient difference at the interface between the conductor layer and the active material layer can be absorbed. Thus, it is possible to bond the conductor layer and the active material layer while suppressing generation of a structural defect such as a crack or interfacial delamination.

### Technology 25

The battery according to any one of technologies 1 to 24,
wherein at least one selected from the group consisting of the first conductor layer and the second conductor layer is a multilayer film.

With this configuration, regarding a surface layer of the conductor layer in contact with the active material layer and regarding an internal layer of the conductor layer, it is possible to change each of: various properties such as hardness, density, thermal expansion coefficient, and thermal conductivity; type of material; curing conditions; and the like. For example, by appropriately selecting the properties, material, and the like regarding the surface layer of the conductor layer, it is possible to improve the adhesion of the bonding surface between the conductor layer and the active material layer. Thus, it is possible to realize a battery having high reliability.

### Technology 26

The battery according to technology 25,
wherein a surface layer forming a main surface of the multilayer film is softer than an internal layer of the multilayer film.

With this configuration, the soft surface layer of the conductor layer can absorb expansion and contraction of the active material layer caused by charging and discharging. Thus, the adhesion of the bonding surface between the conductor layer and the active material layer under a charge-discharge cycle is further improved, and therefore it is possible to realize a battery having high reliability.

### Technology 27

The battery according to technology 25,
wherein the multilayer film includes a thermosetting resin, and wherein a curing temperature of a material of a surface layer forming a main surface of the multilayer film is lower than a curing temperature of a material of an internal layer of the multilayer film.

An internal layer of the conductor layer has a problem in that excessive thermal hysteresis is accumulated in a repetitive curing process of a multilayer film such as curing of a surface layer and the like, and generation of a crack, strength reduction, and the like due to deterioration of a resin component occur easily. However, as in the above configuration, when the material of a surface layer of the conductor layer has a curing temperature lower than that of the material of an internal layer, it is possible to form a conductor layer of the multilayer film while suppressing deterioration of a resin in an inner layer portion. Accordingly, a conductor layer having high bonding reliability with the active material layer can be formed. Thus, it is possible to obtain a battery having high reliability.

### Technology 28

The battery according to any one of technologies 1 to 27,
wherein at least one selected from the group consisting of the first lead-out conductor member and the second lead-out conductor member includes a resin.

With this configuration, the elasticity, that is, the softness of the side-surface insulating layer can absorb deformation of a side-surface portion of the battery, which expands and contracts due to charging and discharging operations. Accordingly, it is possible to suppress peeling of the lead-out conductor member from the side-surface insulating layer. Moreover, due to the sealing properties of a resin material, the lead-out conductor member can suppress entry of water and a gas component that deteriorates the battery characteristics into the battery, and therefore it is possible to obtain a battery having high reliability.

### Technology 29

The battery according to any one of technologies 1 to 28,
wherein at least one selected from the group consisting of the first lead-out conductor member and the second lead-out conductor member is a multilayer film.

With this configuration, in the lead-out conductor member, regarding a surface in contact with the side-surface insulating layer and regarding a surface in contact with a lead terminal, a mount substrate, and the like, it is possible to change each of: various properties such as hardness, density, thermal expansion coefficient, and thermal conductivity; type of material; curing conditions; and the like. Thus, it is possible to improve the adhesion between the lead-out conductor member and the side-surface insulating layer, the lead terminal, and the like. Therefore, the bonding reliability of the lead-out conductor member against a charge-discharge cycle and an external stress is increased. Moreover, it is also possible to use a layer having high density and high sealing properties (such as watertightness and gas-tightness) as an internal layer of the lead-out conductor member. Thus, entry of water or a gas component that deteriorates the battery characteristics into the battery through an interlayer gap in the battery side surface can be suppressed, and it is possible to realize a battery having high reliability.

### Technology 30

The battery according to technology 29,
wherein a surface layer forming a main surface of the multilayer film is softer than an internal layer of the multilayer film.

With this configuration, the soft surface layer of the lead-out conductor member can absorb a stress that is generated, due to expansion and contraction of the battery caused by charging and discharging, at the bonding surface between the lead-out conductor member and the side-surface insulating layer and at the bonding surface between the lead-out conductor member, a lead terminal connected to an external circuit, a mounting substrate, or the like. Thus, the adhesion between the lead-out conductor member and the side-surface insulating layer, the lead terminal, and the like under a charge-discharge cycle and under an external stress is further improved and interfacial delamination in the lead-out conductor member is suppressed, and therefore it is possible to realize a battery having high reliability.

### Technology 31

The battery according to technology 29, further comprising:
a first-side-surface insulating layer that covers a first side surface of a laminated body composed of the first active material layer, the solid electrolyte layer, and the second active material layer; and
a second-side-surface insulating layer that covers a second side surface of the laminated body opposite to the first side surface of the laminated body,
wherein at least a part of the first lead-out conductor member is disposed on a surface of the first-side-surface insulating layer,
wherein at least a part of the second lead-out conductor member is disposed on a surface of the second-side-surface insulating layer,
wherein the multilayer film includes a thermosetting resin, wherein a curing temperature of the thermosetting resin included in the multilayer film is lower than a curing temperature of a thermosetting resin included in the first insulating layer and the second insulating layer, and
wherein a curing temperature of a material of a surface layer forming a main surface of the multilayer film is lower than a curing temperature of a material of an internal layer of the multilayer film.

The side-surface insulating layer and the lead-out conductor member have a problem in that excessive thermal hysteresis is accumulated in a repetitive curing process, and generation of a crack, strength reduction, and the like due to deterioration of a resin component occur easily. However, as in the above configuration, when the curing temperature of a thermosetting resin included in the multilayer film of the lead-out conductor member is lower than the curing temperature of a thermosetting resin included in the first-side-surface insulating layer and the second-side-surface insulating layer and the curing temperature of the material of a surface layer of the multilayer film of the lead-out conductor member is lower than the curing temperature of the material of an internal layer, it is possible to form the side-surface insulating layer and the lead-out conductor member while suppressing accumulation of excessive thermal hysteresis and suppressing resin deterioration. Thus, it is possible to suppress generation of a crack and strength reduction in the side-surface insulating layer and the lead-out conductor member. Accordingly, it is possible to obtain a battery having higher reliability. Moreover, with this configuration, it is possible to selectively make the surface layer of the lead-out conductor member softer than the internal layer.

### Technology 32

The battery according to any one of technologies 1 to 31,
wherein at least one selected from the group consisting of the first lead-out conductor member and the second lead-out conductor member includes a metal plating film provided on a surface thereof.

With this configuration, it is possible to connect the battery according to technology 32 to a lead terminal, a mount substrate, or the like by solder mounting by reflow soldering or the like or by solder connection. Accordingly, it is possible to connect the battery according to technology 32 to an external circuit with a small resistance loss and high reliability in mechanical strength. Moreover, watertightness and gas-tightness are improved due to the sealability of the metal plating film, and therefore it is possible to obtain a battery having high reliability in an actual use environment.

Heretofore, a battery according to the present disclosure has been described based on embodiments. However, the present disclosure is not limited to these embodiments. Within the gist of the present disclosure, the scope of the present disclosure includes various modifications of the embodiments that a person having an ordinary skill in the art can conceive and other embodiments constructed by combining some of the elements of the embodiments.

Various modifications, replacements, additions, and omissions can be made on the embodiments described above within the scope of the claims or the equivalents thereof.

A battery according to the present disclosure is applicable to a secondary battery such as an all-solid-state battery that is used for various electronic appliances, automobiles, and the like.

What is claimed is:

1. A battery comprising:
a first electrode layer;
a second electrode layer; and
a solid electrolyte layer that is disposed between the first electrode layer and the second electrode layer,
wherein the first electrode layer includes a first active material layer, and a first current collector layer and a first conductor layer that are disposed on a first main surface of the first active material layer,
wherein the first conductor layer is made of a material different from a material of the first current collector layer, is positioned adjacent to a first side surface of the battery, and is electrically connected to the first current collector layer, and
wherein the battery further comprises a first lead-out conductor member that is electrically connected to the first conductor layer.

2. The battery according to claim 1,
wherein the second electrode layer includes a second active material layer, and a second current collector layer and a second conductor layer that are disposed on a first main surface of the second active material layer,
wherein the second conductor layer is made of a material different from a material of the second current collector layer, is positioned adjacent to a second side surface of the battery opposite to the first side surface of the battery, and is electrically connected to the second current collector layer, and
wherein the battery further comprises a second lead-out conductor member that is electrically connected to the second conductor layer.

3. The battery according to claim 2, further comprising:
a first-side-surface insulating layer that covers a first side surface of a laminated body composed of the first active material layer, the solid electrolyte layer, and the second active material layer,
wherein at least a part of the first lead-out conductor member is disposed on a surface of the first-side-surface insulating layer.

4. The battery according to claim 3, further comprising:
a second-side-surface insulating layer that covers a second side surface of the laminated body composed of the first active material layer, the solid electrolyte layer, and the second active material layer, the second side surface being opposite to the first side surface of the laminated body,
wherein at least a part of the second lead-out conductor member is disposed on a surface of the second-side-surface insulating layer.

5. The battery according to claim 2,
wherein the first electrode layer further includes a first insulating layer disposed at a position that is on the first main surface of the first active material layer and that is adjacent to the second side surface of the battery.

6. The battery according to claim 5,
wherein the second electrode layer further includes a second insulating layer disposed at a position that is on the first main surface of the second active material layer and that is adjacent to the first side surface of the battery.

7. The battery according to claim 1,
wherein the first lead-out conductor member includes a wraparound portion that is continuous from the first side surface of the battery onto a first main surface of the first conductor layer that does not face the first active material layer, and the first lead-out conductor member is in contact with the first conductor layer at the first main surface of the first conductor layer.

8. The battery according to claim 2,
wherein the second lead-out conductor member includes a wraparound portion that is continuous from the second side surface of the battery onto a first main surface of the second conductor layer that does not face the second active material layer, and the second lead-out conductor member is in contact with the second conductor layer at the first main surface of the second conductor layer.

9. The battery according to claim 7,
wherein a thickness of the wraparound portion of the first lead-out conductor member is smaller than a thickness of the first lead-out conductor member on the first side surface of the battery and a thickness of the first lead-out conductor member on the first main surface of the first conductor layer.

10. The battery according to claim 8,
wherein a thickness of the wraparound portion of the second lead-out conductor member is smaller than a thickness of the second lead-out conductor member on the second side surface of the battery and a thickness of the second lead-out conductor member on the first main surface of the second conductor layer.

11. The battery according to claim 6,
wherein at least one selected from the group consisting of the first insulating layer and the second insulating layer is a plate-shaped member including an inorganic material.

12. The battery according to claim 6,
wherein at least one selected from the group consisting of the first insulating layer and the second insulating layer includes a resin.

13. The battery according to claim 6,
wherein at least one selected from the group consisting of the first insulating layer and the second insulating layer is a multilayer film.

14. The battery according to claim 4,
wherein at least one selected from the group consisting of the first-side-surface insulating layer and the second-side-surface insulating layer includes a resin.

15. The battery according to claim 4,
wherein at least one selected from the group consisting of the first-side-surface insulating layer and the second-side-surface insulating layer is a multilayer film.

16. The battery according to claim 2,
wherein at least one selected from the group consisting of the first conductor layer and the second conductor layer is a plate-shaped member including a metal material.

17. The battery according to claim 2,
wherein at least one selected from the group consisting of the first conductor layer and the second conductor layer includes a resin.

18. The battery according to claim 2,
wherein at least one selected from the group consisting of the first conductor layer and the second conductor layer is a multilayer film.

19. The battery according to claim 2,
wherein at least one selected from the group consisting of the first lead-out conductor member and the second lead-out conductor member includes a resin.

20. The battery according to claim 2,
wherein at least one selected from the group consisting of the first lead-out conductor member and the second lead-out conductor member is a multilayer film.
